(19) United States
(12) Patent Application Publication
(10) Pub. No.: US 2007/0174566 A1
(43) Pub. Date: Jul. 26, 2007

(54) Method of replicating data in a computer system containing a virtualized data storage area

(76) Inventors: Yasunori Kaneda, Sagamihara (JP); Yuichi Taguchi, Sagamihara (JP); Naoko Maruyama, Kawasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/372,122

(22) Filed: Mar. 10, 2006

(30) Foreign Application Priority Data
Jan. 23, 2006 (JP) 2006-13952

(51) Int. Cl. G06F 12/16

(52) U.S. Cl. 711/162

(57) ABSTRACT

Provided is a computer system capable of reducing a load on a virtualization apparatus during backup processing, including: at least one first storage system; at least one second storage system; a virtualization apparatus; at least one host computer; a backup unit; and a data transmission unit having access to the first storage system, in which, when requested to take a backup of the virtualized data storage area, the backup unit obtains mapping information which indicates association between the virtualized data storage area and the first data storage area where data requested to be written in the virtualized data storage area is stored, and identifies, based on the obtained mapping information, the first data storage area corresponding to the virtualized data storage area that is requested to be backed up, and in which the data transmission unit transfers, to the storage unit of the second storage system, a copy of data stored in the first data storage area that is identified by the backup unit.

### CLAIM OF PRIORITY

The present application claims priority from Japanese patent application P2006-13952 filed on Jan. 23, 2006, the content of which is hereby incorporated by reference into this application.

### BACKGROUND

This invention relates to a computer system having a first storage system, a second storage system, a virtualization apparatus, and a host computer, and more specifically to a technique of backing up data that is stored in the first storage system to the second storage system.

Virtualization apparatuses with a virtualization function have recently been put into practice. A virtualization apparatus is connected between a computer and a storage system to provide the computer with a virtual storage area (virtualized data storage area). The virtualization function is obtained by various methods. Methods proposed to give the virtualization function include one that uses a storage system to obtain the virtualization function, one that uses a fibre channel switch to obtain the virtualization function, and one that uses a computer to obtain the virtualization function. The method of obtaining the virtualization function through a storage system is disclosed in JP 2004-5370 A.

Computer systems take a backup for data protection. For instance, a computer system takes a backup by storing a copy of data that is stored in a storage system in another storage system. Backup techniques for a computer system that has plural storage systems are disclosed in U.S. Pat. No. 6,269,431 B and U.S. Pat. No. 6,353,878 B.

### SUMMARY

An example is given in which a backup computer provided in a computer system uses the backup techniques described above to take a backup of data stored in a virtualized data storage area, which is provided by a virtualization apparatus. The backup computer is a computer that performs backup processing in a virtualized environment.

The backup computer first obtains, through the virtualization apparatus, a copy of data stored in a virtualized data storage area. The backup computer then stores the obtained backup data in another storage system. The backup computer thus takes a backup of data stored in the virtualized data storage area.

This type of computer system where backup processing is executed in a virtualized environment lets backup data pass through the virtualization apparatus, and therefore has a problem in that the virtualization apparatus is loaded down with the load of backup processing.

A representative aspect of this invention has been made in view of the aforementioned problem, and it is therefore an object of this invention to provide a computer system that lessens the load on a virtualization apparatus during backup processing.

According to a representative aspect of this invention, a computer system is characterized by including: at least one first storage system; at least one second storage system; a virtualization apparatus connected to the first storage system; at least one host computer connected to the virtualization apparatus; a backup unit having access to the virtualization apparatus; and a data transmission unit having access to the first storage system, the second storage system, and the backup unit. The computer system is further characterized in that: each first storage system includes a first interface connected to the virtualization apparatus, a first processor connected to the first interface, a first memory connected to the first processor, and a first disk drive for storing data requested by the host computer to be written; each second storage system includes a second interface connected externally, a second processor connected to the second interface, a second memory connected to the second processor, and a storage unit for storing a copy of data stored in the first disk drive; the virtualization apparatus includes a third interface connected to the first storage system and the host computer, a third processor connected to the third interface, and a third memory connected to the third processor; the third processor provides, to the host computer, a virtualized data storage area in which data is requested to be written by the host computer; the first processor provides a data storage area of the first disk drive as at least one first data storage area to the virtualization apparatus, and stores in the first data storage area data that is requested to be written in the virtualized data storage area; , when requested to take a backup of the virtualized data storage area, the backup unit obtains mapping information which indicates association between the virtualized data storage area and the first data storage area where data requested to be written in the virtualized data storage area is stored, and identifies, based on the obtained mapping information, the first data storage area corresponding to the virtualized data storage area that is requested to be backed up; and the data transmission unit transfers, to storage unit of the second storage system, a copy of data stored in the first data storage area that is identified by the backup unit.

According to the representative aspect of this invention, the computer system is capable of reducing the load applied to a virtualization apparatus in backup processing.

### BRIEF DESCRIPTION OF THE DRAWINGS

The present invention can be appreciated by the description which follows in conjunction with the following figures, wherein:

FIG. 1 is a block diagram showing a configuration of a computer system according to a first embodiment of this invention;

FIG. 2 is a block diagram showing a configuration of a computer according to the first embodiment of this invention;

FIG. 3A is a block diagram showing a configuration of a virtualization apparatus according to the first embodiment of this invention;

FIG. 3B is a block diagram showing a configuration of a modification example of the virtualization apparatus according to the first embodiment of this invention;

FIG. 4 is a block diagram showing a configuration of a storage system according to the first embodiment of this invention;

FIG. 5 is a block diagram showing a configuration of a tape library device according to the first embodiment of this invention;

FIG. 6 is a block diagram showing a configuration of a backup computer according to the first embodiment of this invention;

FIG. 7 is a block diagram showing a configuration of a management computer according to the first embodiment of this invention;

FIG. 8 is a configuration diagram of a data storage area identification information table which is stored in the computer according to the first embodiment of this invention;

FIG. 9A is a configuration diagram of mapping information which is stored in the virtualization apparatus according to the first embodiment of this invention;

FIG. 9B is a configuration diagram of mapping information which is stored in the virtualization apparatus according to the first embodiment of this invention;

FIG. 9C is a configuration diagram of mapping information which is stored in the virtualization apparatus according to the first embodiment of this invention;

FIG. 10A is an explanatory diagram of a virtualized data storage area configuration GUI which is displayed by the management computer according to the first embodiment of this invention;

FIG. 10B is an explanatory diagram of a virtualized data storage area configuration GUI which is displayed by the management computer according to the first embodiment of this invention;

FIG. 10C is an explanatory diagram of a virtualized data storage area configuration GUI which is displayed by the management computer according to the first embodiment of this invention;

FIG. 10D is an explanatory diagram of a virtualized data storage area configuration GUI which is displayed by the management computer according to the first embodiment of this invention;

FIG. 11 is an explanatory diagram of virtualized data storage areas provided by the virtualization apparatus according to the first embodiment of this invention;

FIG. 12A is an explanatory diagram of a read request issued by the computer according to the first embodiment of this invention;

FIG. 12B is an explanatory diagram of a read request converted by the virtualization apparatus according to the first embodiment of this invention;

FIG. 13A is an explanatory diagram of a write request issued by the computer according to the first embodiment of this invention;

FIG. 13B is an explanatory diagram of a write request converted by the virtualization apparatus according to the first embodiment of this invention;

FIG. 14 is an explanatory diagram of a backup request according to the first embodiment of this invention;

FIG. 15 is a flow chart for backup processing of the backup computer according to the first embodiment of this invention;

FIG. 16 is an explanatory diagram of a backup request according to the first embodiment of this invention;

FIG. 17 is an explanatory diagram of a flow of backup data in a computer system that executes backup processing in a virtualized environment;

FIG. 18 is an explanatory diagram of a flow of backup data in the computer system according to the first embodiment of this invention;

FIG. 19 is an explanatory diagram of a restoration request according to the first embodiment of this invention;

FIG. 20 is a flow chart for restoration processing of the backup computer according to the first embodiment of this invention;

FIG. 21 is a block diagram showing a configuration of a computer system according to a first modification example;

FIG. 22 is a block diagram showing a configuration of a tape library device that is provided in the computer system according to the first modification example;

FIG. 23 is a block diagram showing a configuration of a computer system according to a second modification example;

FIG. 24 is a block diagram showing a configuration of a virtualization apparatus that is provided in the computer system according to the second modification example;

FIG. 25 is a block diagram showing a configuration of a data transmission computer which is provided in the computer system according to the second modification example;

FIG. 26 is a flow chart for restoration processing of a computer system according to a second embodiment of this invention;

FIG. 27 is a block diagram showing a configuration of a computer system according to a third embodiment of this invention;

FIG. 28 is a block diagram showing a configuration of a storage system that is provided in the computer system according to the third embodiment of this invention;

FIG. 29 is a configuration diagram of mapping information that is stored in a virtualization apparatus according to the third embodiment of this invention;

FIG. 30 is an explanatory diagram of virtualized data storage areas provided by the virtualization apparatus according to the third embodiment of this invention;

FIG. 31 is an explanatory diagram of a backup request according to the third embodiment of this invention; and

FIG. 32 is a flow chart for backup processing of a backup computer according to the third embodiment of this invention.

### DETAILED DESCRIPTION OF THE PREFERRED EMBODIMENTS

Embodiments of this invention will be described below with reference to the accompanying drawings.

### FIRST EMBODIMENT

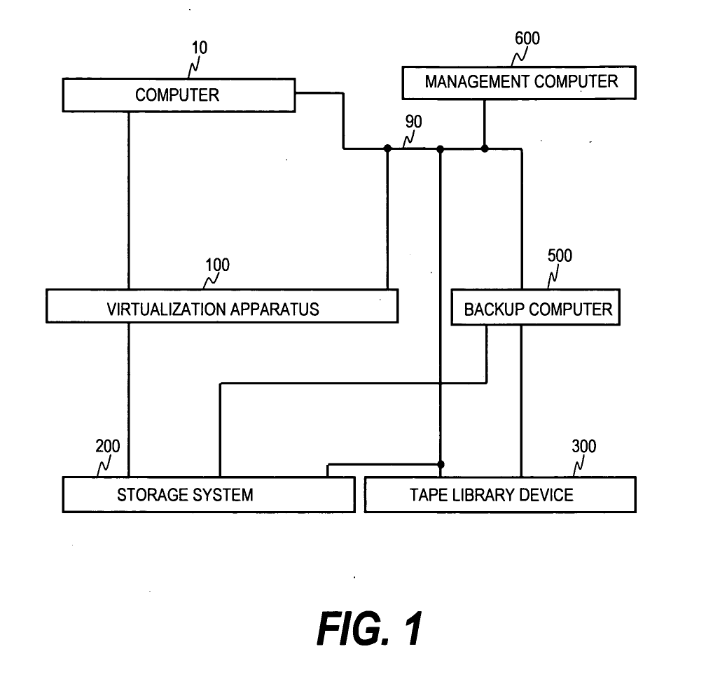

FIG. 1 is a block diagram showing a configuration of a computer system according to a first embodiment of this invention.

The computer system has a computer 10, a virtualization apparatus 100, a storage system 200, a tape library device 300, a backup computer 500, and a management computer 600.

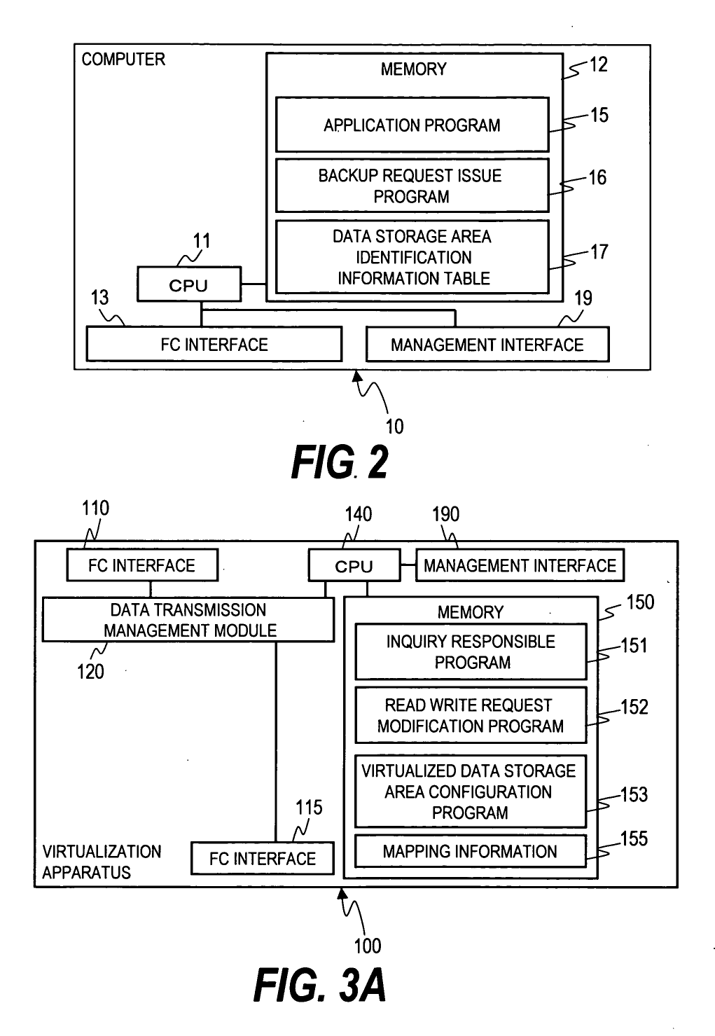

The computer 10 is connected to the virtualization apparatus 100 via a network to which a fibre channel protocol is applied. The computer 10 is also connected to the backup computer 500 and the management computer 600 via a management network 90. The computer 10 issues a data read request and a data write request to read and write data in a virtualized data storage area of the virtualization apparatus 100. Details of the computer 10 will be described with reference to FIG. 2.

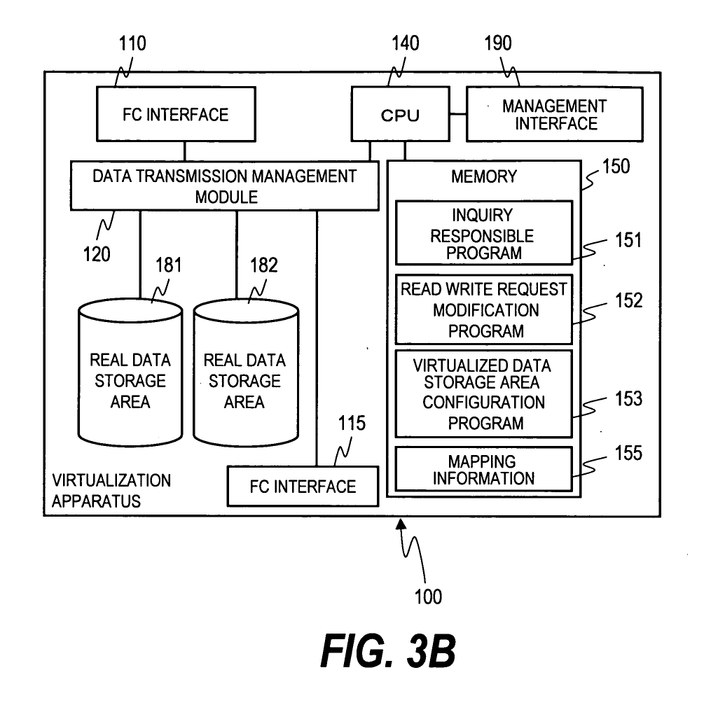

The virtualization apparatus 100 is connected to the computer 10 and the storage system 200 via the network to which a fibre channel protocol is applied. The virtualization apparatus 100 is also connected to the backup computer 500 and the management computer 600 via the management network 90. The virtualization apparatus 100 provides, to the computer 10, a real data storage area of the storage system 200 as a virtualized data storage area of the virtualization apparatus 100. Details of the virtualization apparatus 100 will be described with reference to FIGS. 3A and 3B.

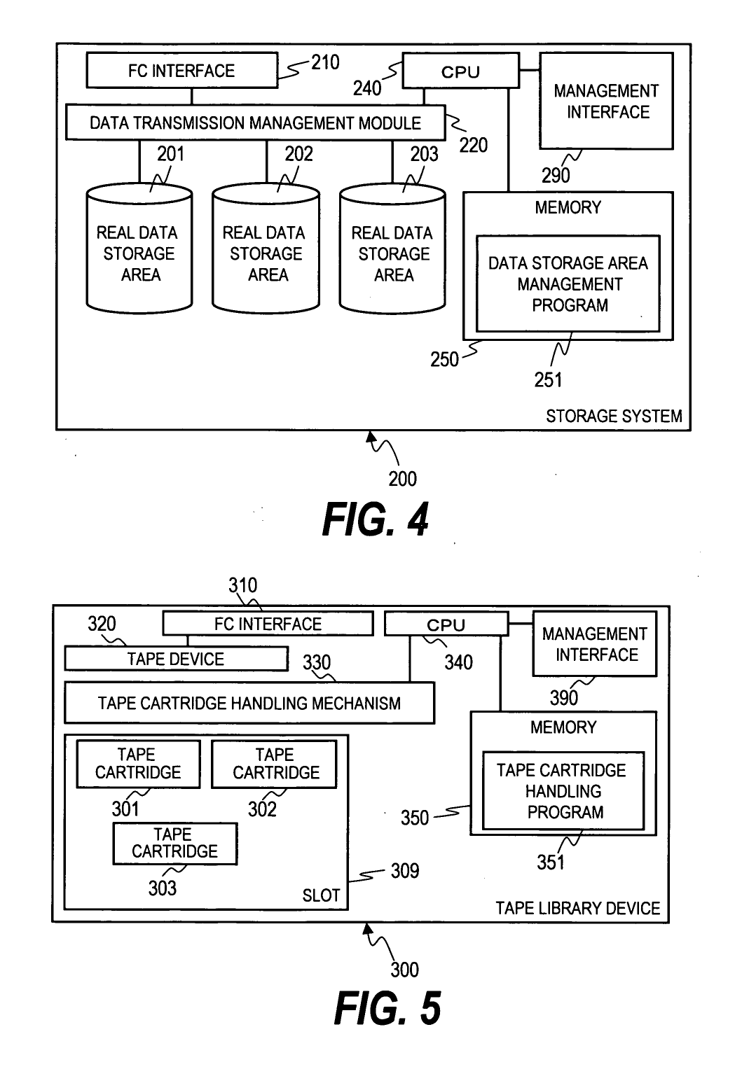

The storage system 200 is connected to the virtualization apparatus 100 and the backup computer 500 via the network to which a fibre channel protocol is applied. The storage system 200 is also connected to the management computer 600 via the management network 90. The storage system 20 stores, in a real data storage area, data requested by the computer 10 to be written in a virtualized data storage area of the virtualization apparatus 100. Details of the storage system 200 will be described with reference to FIG. 4.

The tape library device 300 is connected to the backup computer 500 via the network to which a fibre channel protocol is applied. The tape library device 300 is also connected to the management computer 600 via the management network 90. The tape library device 300 stores a copy of data that is stored in a real data storage area of the storage system 200. Details of the tape library device 300 will be described with reference to FIG. 5.

The computer system of this embodiment may have a backup storage system instead of the tape library device 300. The backup storage system may be similar to the storage system 200, which is described with reference to FIG. 4. In short, the backup storage system can have any configuration as long as data stored in a real data storage area of the storage system 200 can be backed up to the backup storage system.

The backup computer 500 is connected to the storage system 200 and the tape library device 300 via the network to which a fibre channel protocol is applied. This means that the backup computer 500 is connected to the storage system 200 and the tape library device 300 without interposing the virtualization apparatus 100. The backup computer 500 can thus copy data stored in the storage system 200 to the tape library device 300 without the intervention of the virtualization apparatus 100.

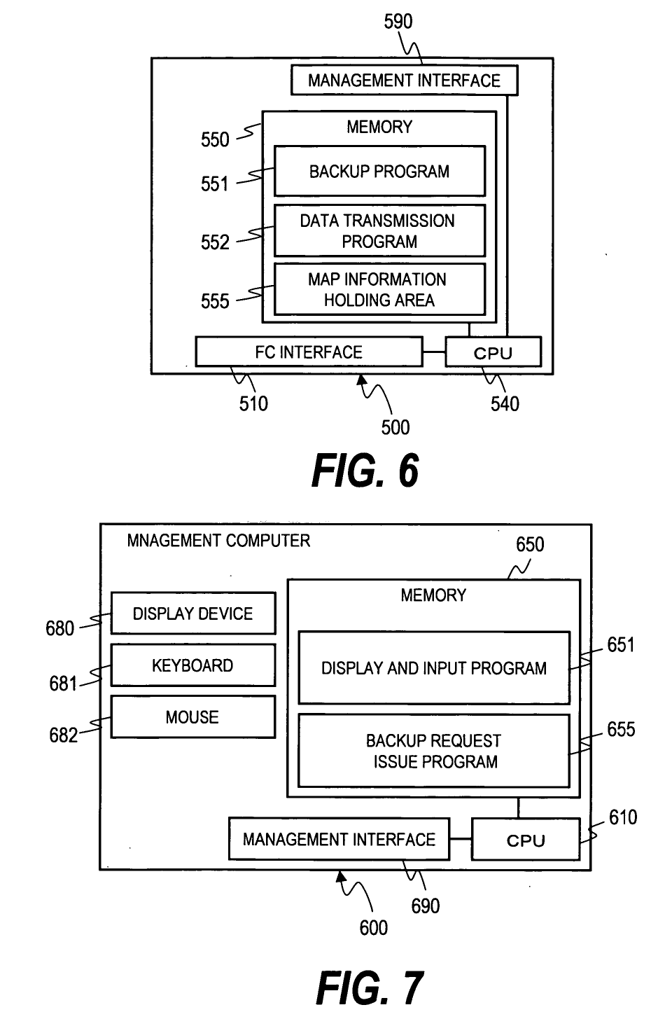

The backup computer 500 is also connected to the computer 10, the virtualization apparatus 100, and the management computer 600 via the management network 90. The backup computer 500 controls processing of backing up data that is stored in a real data storage area of the storage system 200. Details of the backup computer 500 will be described with reference to FIG. 6.

The management computer 600 is connected to the computer 10, the virtualization apparatus 100, the storage system 200, the tape library device 300, and the backup computer 500 via the management network 90. The management computer 600 handles the overall control of the computer system. Details of the management computer 600 will be described with reference to FIG. 7.

The computer system, which, in FIG. 1, has one computer 10, one virtualization apparatus 100, and one storage system 200, may have as many computers, virtualization apparatuses, and storage systems as necessary. Also, the computer system of this embodiment may employ a network to which an Internet protocol is applied instead of the network to which a fibre channel protocol is applied.

FIG. 2 is a block diagram showing the configuration of the computer 10 according to the first embodiment of this invention.

The computer 10 has a CPU 11, a memory 12, an FC interface 13, and a management interface 19.

The FC interface 13 is connected to the virtualization apparatus 100 via the network to which a fibre channel protocol is applied. The management interface 19 is connected to the backup computer 500 and the management computer 600 via the management network 90.

The CPU 11 performs various types of processing by executing programs stored in the memory 12. The memory 12 stores information including programs that are executed by the CPU 11. Specifically, the memory 12 stores an application program 15, a backup request issuing program 16, and a data storage area identification information table 17.

The application program 15 issues a read request or a write request to the virtualization apparatus 100, thereby processing data.

The backup request issuing program 16 issues, to the backup computer 500, a request to back up data that is stored in a real data storage area of the storage system 200. The CPU 11 of the computer 10 executes the backup request issuing program 16 when it is necessary to back up a data storage area that is used by the computer 10.

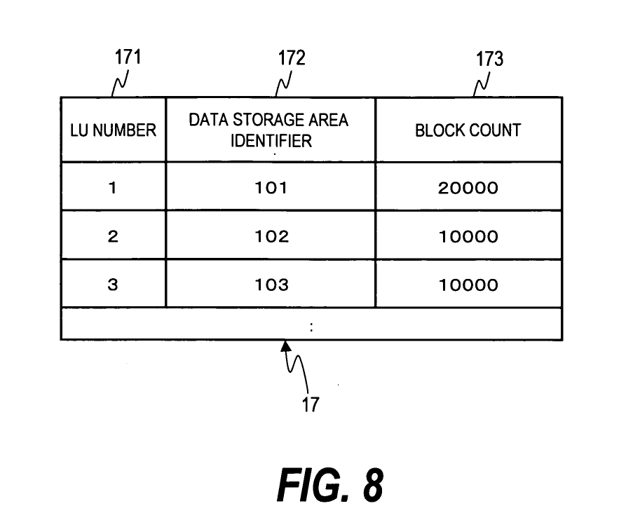

The data storage area identification information table 17 is information about virtualized data storage areas provided by the virtualization apparatus 100. Details of the data storage area identification information table 17 will be described with reference to FIG. 8.

FIG. 3A is a block diagram showing the configuration of the virtualization apparatus 100 according to the first embodiment of this invention.

The virtualization apparatus 100 has an FC interface 110, an FC interface 115, a data transmission management module 120, a CPU 140, a memory 150, and a management interface 190.

The FC interface 110 is connected to the computer 10 via the network to which a fibre channel protocol is applied. The FC Interface 115 is connected to the storage system 200 via the network to which a fibre channel protocol is applied. The management interface 190 is connected to the backup computer 500 and the management computer 600 via the management network 90.

The data transmission management module 120 controls data transmission among the FC interface 110, the FC interface 115, and the CPU 140.

The CPU 140 performs various types of processing by executing programs stored in the memory 150. Specifically, the CPU 140 processes a read request and a write request that are issued by the computer 10. The CPU 140 also controls virtualized data storage areas provided to the computer 10.

The memory 150 stores information including programs that are executed by the CPU 140. Specifically, the memory 150 stores an inquiry responding program 151, a read write request modification program 152, a virtualized data storage area configuration program 153, and mapping information 155.

The inquiry responding program 151 receives an Inquiry command from the computer 10, and responds to the received Inquiry command. An Inquiry command is a command for confirming the existence of a data storage area.

The read write request modification program 152 analyzes a read request or a write request that is issued by the computer 10. The read write request modification program 152 modifies the analyzed read request into a read request addressed to the storage system 200. The read write request modification program 152 modifies the analyzed write request into a write request addressed to the storage system 200.

The virtualized data storage area configuration program 153 builds virtualized data storage areas and provides the built virtualized data storage areas to the computer 10.

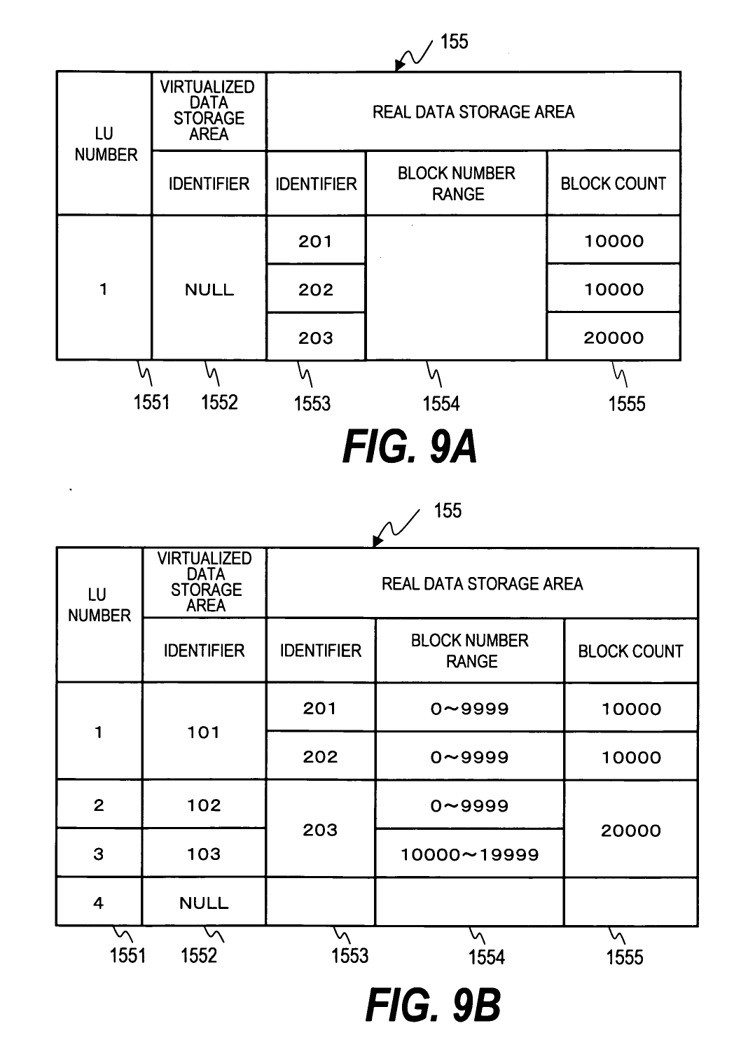

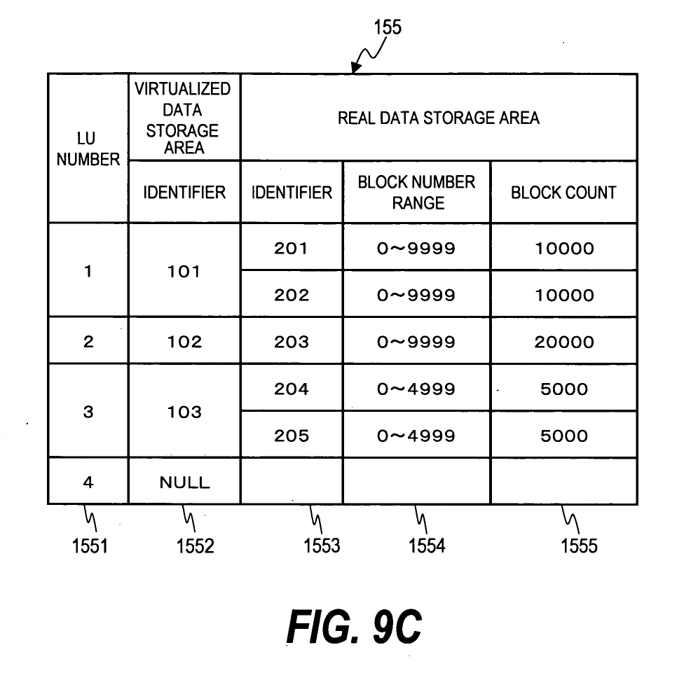

The mapping information 155 indicates the association between a virtualized data storage area of the virtualization apparatus 100 and a real data storage area of the storage system 200. Details of the mapping information 155 will be described with reference to FIGS. 9A, 9B, and 9C.

Next, a modification example of the virtualization apparatus 100 will be described.

FIG. 3B is a block diagram showing the configuration of a modification example of the virtualization apparatus 100 according to the first embodiment of this invention.

The virtualization apparatus 100 of FIG. 3B has a disk drive, and provides data storage areas of the disk drive as real data storage areas 181 and 182 to the computer 10. This means that the computer 10 can issue a data read request and a data write request to the real data storage areas 181 and 182 of the virtualization apparatus 100 in addition to virtualized data storage areas of the virtualization apparatus 100.

The rest of the configuration of the virtualization apparatus 100 shown in FIG. 3B is the same as that of the virtualization apparatus of FIG. 3A. Components common to the two are denoted by the same reference numerals to avoid repeating the description.

FIG. 4 is a block diagram showing the configuration of the storage system 200 according to the first embodiment of this invention.

The storage system 200 has an FC interface 210, a data transmission management module 220, a CPU 240, a memory 250, a management interface 290, and a disk drive.

The FC interface 210 is connected to the virtualization apparatus 100 and backup computer 500 via the network to which a fibre channel protocol is applied. The management interface 290 is connected to the management computer 600 via the management network 90.

The data transmission management module 220 controls data transmission among the FC interface 210, the CPU 240 and the disk drive.

The CPU 240 performs various types of processing by executing programs stored in the memory 250.

The memory 250 stores information including programs that are executed by the CPU 240. Specifically, the memory 250 stores a data storage area management program 251.

The data storage area management program 251 processes a read request and a write request that are received from the virtualization apparatus 100. The data storage area management program 251 also provides data storage areas of the disk drive as real data storage areas 201 to 203 to the virtualization apparatus 100.

The data storage area management program 251 may build a RAID group from plural disk drives. In this case, the data storage area management program 251 provides the RAID group as one or more real data storage areas 201 to 203 to the virtualization apparatus 100.

FIG. 5 is a block diagram showing the configuration of the tape library device 300 according to the first embodiment of this invention.

The tape library device 300 has tape cartridges 301 to 303, a slot 309, an FC interface 310, a tape device 320, a tape cartridge handling mechanism 330, a CPU 340, and a memory 350.

The FC interface 310 is connected to the backup computer 500 via the network to which a fibre channel protocol is applied. The management interface 390 is connected to and the management computer 600 via the management network 90.

The tape cartridges 301 to 303 store a copy of data that is stored in the real data storage areas 201 to 203 of the storage system 200. The tape cartridges 301 to 303 are stored in the slot 309. The tape library device 300, which, in FIG. 5, has three tape cartridges 301 to 303, may have as many tape cartridges as necessary.

The tape device 320 reads and writes data in the tape cartridges 301 to 303 loaded in the tape device 320. The tape cartridge handling mechanism 330 loads the tape cartridges 301 to 303 in and out of which data is written and read in the tape device 320.

The CPU 340 performs various types of processing by executing programs stored in the memory 350. Specifically, the CPU 340 controls the tape cartridge handling mechanism 330.

The memory 350 stores information including programs that are executed by the CPU 340. Specifically, the memory 350 stores a tape cartridge handling program 351.

The tape cartridge handling program 351 receives a tape cartridge mounting request containing an identifier of the tape cartridges 301 to 303. Upon reception of the request, the tape cartridge handling program 351 controls the tape cartridge handling mechanism 330 to have the mechanism load one of the tape cartridges 301 to 303 that is identified by an identifier contained in the tape cartridge mount request in the tape device 320.

The tape cartridge handling program 351 also receives a tape cartridge unmounting request. Upon reception of the request, the tape cartridge handling program 351 controls the tape cartridge handling mechanism 330 to have the mechanism remove the tape cartridges 301 to 303 from the tape device 320. Then the tape cartridge handling program 351 controls the tape cartridge handling mechanism 330 to have the mechanism store the removed tape cartridges 301 to 303 in the slot 309.

FIG. 6 is a block diagram showing the configuration of the backup computer 500 according to the first embodiment of this invention.

The backup computer 500 has an FC interface 510, a CPU 540, a memory 550, and a management interface 590.

The FC interface 510 is connected to the storage system 200 and tape library device 300 via the network to which a fibre channel protocol is applied. The management interface 590 is connected to the computer 10, the virtualization apparatus 100, and the management computer 600 via the management network 90.

The CPU 540 performs various types of processing by executing programs stored in the memory 550.

The memory 550 stores information including programs that are executed by the CPU 540. Specifically, the memory 550 stores a backup program 551 and a data transmission program 552. The memory 550 contains mapping information holding area 555.

The backup control program 551 controls processing of backing up data that is stored in the real data storage. areas 201 to 203 of the storage system 200. The data transmission program 552 controls data transmission between the storage system 200 and the tape library device 300.

The mapping information holding area 555 stores a copy of the mapping information 155, which is stored in the memory 150 of the virtualization apparatus 100.

FIG. 7 is a block diagram showing the configuration of the management computer 600 according to the first embodiment of this invention.

The management computer 600 has a CPU 610, a memory 650, a management interface 690, a display device 680, a keyboard 681, and a mouse 682.

The management interface 690 is connected to the computer 10, the virtualization apparatus 100, the storage system 200, the tape library device 300, and the backup computer 500 via the management network 90.

The CPU 610 performs various types of processing by executing programs stored in the memory 650.

The memory 650 stores information including programs that are executed by the CPU 610. Specifically, the memory 650 stores a display and input program 651 and a backup request issuing program 655.

The display and input program 651 makes the display device 680 display various types of information. The display and input program 651 also obtains information inputted through the keyboard 681 and the mouse 682.

The backup request issuing program 655 is identical with the backup request issuing program 16, which is stored in the memory 12 of the computer 10. Specifically, the backup request issuing program 655 issues, to the backup computer 500, a request to backup data stored in a real data storage area of the storage system 200. It is sufficient if at least one of the computer 10 and the management computer 600 has the backup request issuing program 16 or 655.

The display device 680 displays various types of information. An administrator enters various types of information through the keyboard 681 and the mouse 682.

FIG. 8 is a configuration diagram of the data storage area identification information table 17 stored in the computer 10 according to the first embodiment of this invention.

The data storage area identification information table 17 contains an LU (Logical Unit) number 171, a data storage area identifier 172, and a block count 173.

The LU number 171 indicates an identifier for enabling the computer 10 to identify a virtualized data storage area of the virtualization apparatus 100.

The data storage area identifier 172 indicates an identifier unique to a virtualized data storage area in question. The data storage area identifier 172 in a storage system to which a fibre channel protocol is applied contains a WWN (World Wide Name), an LU (Logical Unit) number, a vendor name, a model name, and the like. In this embodiment, a number assigned to a virtualized data storage area in the drawings serves as the data storage area identifier 172.

The block count 173 indicates the count of blocks contained in this virtualized data storage area.

FIG. 9A, FIG. 9B and FIG. 9C are configuration diagrams of the mapping information 155 stored in the virtualization apparatus 100 according to the first embodiment of this invention.

The mapping information 155 contains an LU number 1551, a virtualized data storage area identifier 1552, a real data storage area identifier 1553, a real data storage area block number range 1554 and a real data storage area block count 1555.

The LU number 1551 indicates an identifier for enabling the computer 10 to identify a virtualized data storage area of the virtualization apparatus 100.

The virtualized data storage area identifier 1552 indicates an identifier unique to a virtualized data storage area in question. The virtualized data storage area identifier 1552 in a storage system to which a fibre channel protocol is applied contains a WWN (World Wide Name), an LU (Logical Unit) number, a vendor name, a model name, and the like. In this embodiment, a number assigned to a virtualized data storage area in the drawings serves as the virtualized data storage area identifier 1552.

The real data storage area identifier 1553 indicates an identifier unique to the real data storage area, 201, 202, or 203, which stores data requested to be written in the virtualized data storage area in question. The real data storage area identifier 1553 in a real data storage system to which a fibre channel protocol is applied contains a WWN (World Wide Name), an LU (Logical Unit) number, a vendor name, a model name, and the like. In this embodiment, a number assigned to the real data storage areas 201 to 203 in the drawings serves as the real data storage area identifier 1553.

The real data storage area block number range 1554 indicates from which block to which block out of the blocks contained in the real data storage area, 201, 202, or 203, which stores data requested to be written in the virtualized data storage area that is identified by the virtualized data storage area identifier 1552.

The real data storage area block count 1555 indicates how many of the blocks contained in the corresponding real data storage area, 201, 202 or 203, store data that is requested to be written in the virtualized data storage area that is identified by the virtualized data storage area identifier 1552.

Described next is processing through which the virtualization apparatus 100 builds virtualized data storage areas.

The CPU 140 of the virtualization apparatus 100 first executes the virtualized data storage area configuration program 153, which is stored in the memory 150, to build virtualized data storage areas.

The CPU 140 of the virtualization apparatus 100 recognizes the real data storage areas 201 to 203 of the storage system 200 through the FC interface 115. The CPU 140 of the virtualization apparatus 100 stores, in the mapping information 155, information about the real data storage areas 201 to 203 recognizable through the FC interface 115.

The mapping information 155 at this point is as shown in FIG. 9A. In the mapping information 155 of FIG. 9A, the identifiers of the real data storage areas 201 to 203 recognizable to the virtualization apparatus 100 are stored the real data storage area identifier 1553.

The administrator now enters in the management computer 600 a request to build virtualized data storage areas. Then the CPU 140 of the virtualization apparatus 100 updates the mapping information 155 stored in the memory 150, and virtualized data storage areas are thus constructed.

Specifically, the CPU 610 of the management computer 600 executes to display and input program 651 to carry out the processing. The CPU 610 of the management computer 600 first requests the virtualization apparatus 100 to transfer the mapping information 155. By making this request, the CPU 610 of the management computer 600 receives the mapping information 155 from the virtualization apparatus 100.

The CPU 610 of the management computer 600 creates a virtualized data storage area configuration GUI 700 based on the received mapping information 155. The created virtualized data storage area configuration GUI 700 is displayed on the display device 680 by the CPU 610 of the management computer 600.

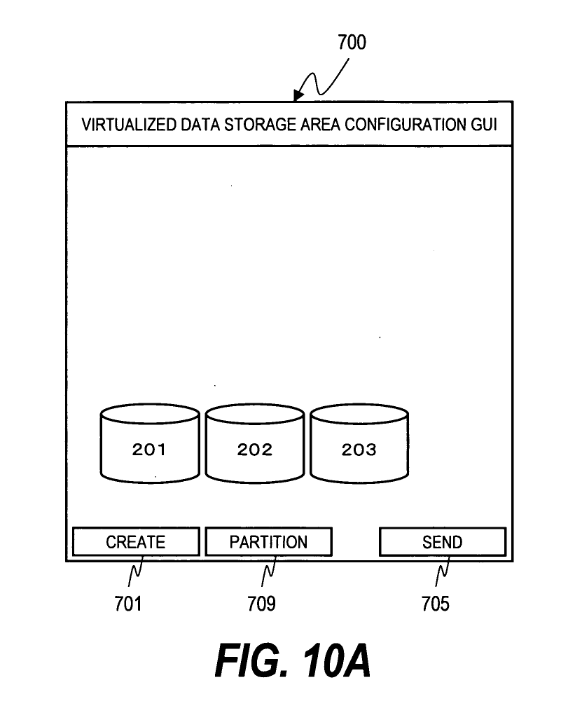

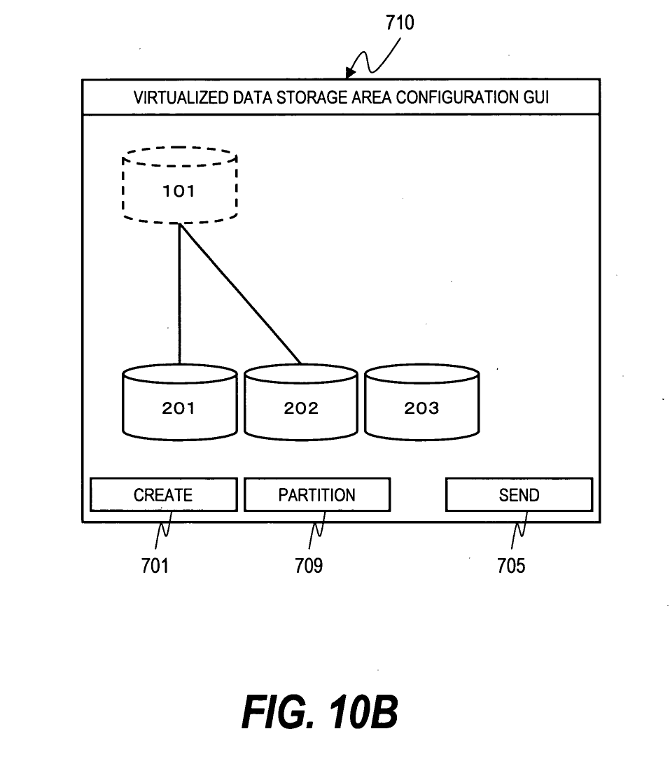

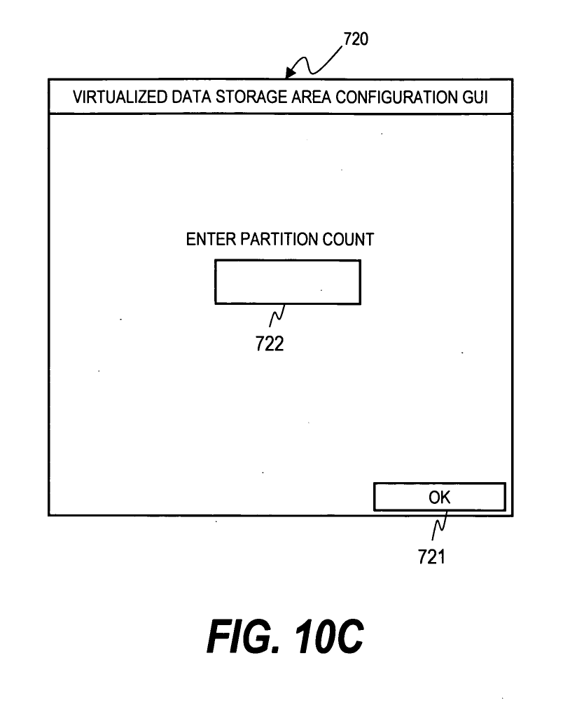

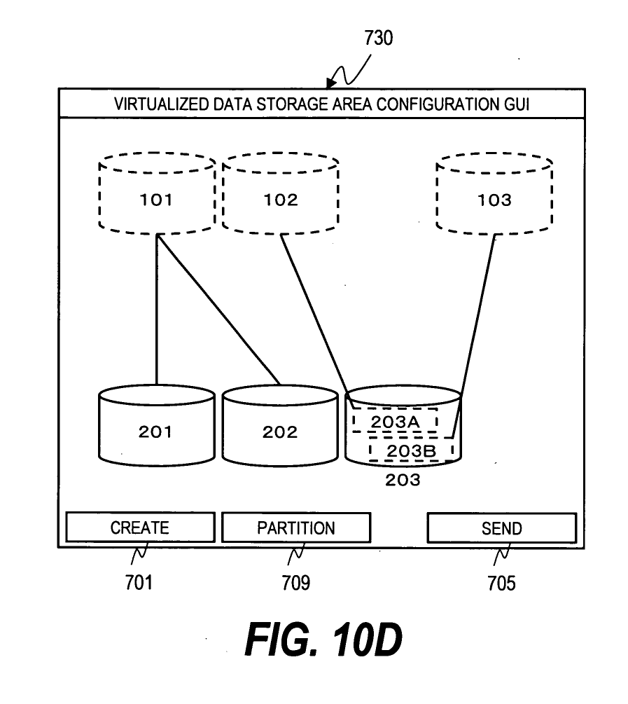

FIG. 10A is an explanatory diagram of the virtualized data storage area configuration GUI 700 displayed by the management computer 600 according to the first embodiment of this invention.

The virtualized data storage area configuration GUI 700 displays identifiers that are stored as the real data storage area identifier 1553 in the mapping information 155. The virtualized data storage area configuration GUI 700 of this embodiment shows that the virtualization apparatus 100 can recognize the real data storage areas 201, 202 and 203.

The virtualized data storage area configuration GUI 700 contains a create button 701, a partition button 709 and a send button 705.

Consider a case in which the administrator chooses the real data storage area 201 and the real data storage area 202 and then operates the create button 701. This causes the CPU 610 of the management computer 600 to create a virtualized data storage area configuration GUI 710. The CPU 610 of the management computer 600 has the display device 680 display the created virtualized data storage area configuration GUI 710.

The partition button 709 will be described with reference to FIG. 10B. The send button 705 will be described with reference to FIG. 10D.

FIG. 10B is an explanatory diagram of the virtualized data storage area configuration GUI 710 displayed by the management computer 600 according to the first embodiment of this invention.

The virtualized data storage area configuration GUI 710 shows that the virtualized data storage area 101 is to be created, and that the virtualized data storage area 101 corresponds to the real data storage area 201 and the real data storage area 202. In this embodiment, the virtualized data storage area 101, which does not actually store data, is drawn in dotted line.

The virtualized data storage area configuration GUI 701 contains the create button 701, the partition button 709 and the send button 705. The create button 701 and the send button 705 are the same as those in the virtualized data storage area configuration GUI 700 of FIG. 10A, and their descriptions will not be repeated here.

Consider a case in which the administrator chooses the real data storage area 203 and then operates the partition button 709. This causes the CPU 610 of the management computer 600 to create a virtualized data storage area configuration GUI 720. The CPU 610 of the management computer 600 has the display device 680 display the created virtualized data storage area configuration GUI 720.

FIG. 10C is an explanatory diagram of the virtualized data storage area configuration GUI 720 displayed by the management computer 600 according to the first embodiment of this invention.

The virtualized data storage area configuration GUI 720 contains a partition count input field 722 and an OK button 721. To create a virtualized data storage area, the administrator enters, in the partition count input field 722, into how many pieces the real data storage area 203, which has been chosen in the virtualized data storage area configuration GUI 710, is to be partitioned.

Consider a case in which the administrator enters “2” into the partition count input field 722 and then operates the OK button 721. This causes the CPU 610 of the management computer 600 to create a virtualized data storage area configuration GUI 730. The CPU 610 of the management computer 600 has the display device 680 display the created virtualized data storage area configuration GUI 730.

The CPU 610 of the management computer 600 equally divides the real data storage area 203 into as many pieces as a numerical value entered in the partition count input field 722 of the virtualized data storage area configuration GUI 720. However, the CPU 610 of the management computer 600 does not always have to divide the real data storage area 203 equally. In the case where the real data storage area 203 is to be divided unequally, the virtualized data storage area configuration GUI 720 contains a field for entering a storage capacity that the real data storage area 203 is to have after partitioned.

FIG. 10D is an explanatory diagram of the virtualized data storage area configuration GUI 730 displayed by the management computer 600 according to the first embodiment of this invention.

The virtualized data storage area configuration GUI 730 shows that the virtualized data storage areas 101, 102 and 103 are to be created, and that the virtualized data storage area 101 corresponds to the real data storage area 201 and the real data storage area 202. The virtualized data storage area configuration GUI 730 also shows that the virtualized data storage area 102 corresponds to a part of the real data storage area 203 that is denoted by 203A whereas the virtualized data storage area 103 corresponds to a part of the real data storage area 203 that is denoted by 203B. In this embodiment, the virtualized data storage areas 101, 102 and 103, which do not actually store data, are drawn in dotted line.

The virtualized data storage area configuration GUI 730 contains the create button 701, the partition button 709, and the send button 705. The create button 701 and the partition button 709 are the same as those in the virtualized data storage area configuration GUI 700 of FIG. 10A, and their descriptions will not be repeated here.

When the administrator operates the send button 705 on the virtualized data storage area configuration GUI 730, the CPU 610 of the management computer 600 updates the mapping information 155 received from the virtualization apparatus 100 so that the mapping information 155 reflects the configuration displayed on the virtualized data storage area configuration GUI 730.

Specifically, the CPU 610 of the management computer 600 chooses a record entry of the mapping information 155 whose real data storage area identifier 1553 matches the identifier of the real data storage area 201. The CPU 610 of the management computer 600 next stores the identifier of the virtualized data storage area 101, which corresponds to the real data storage area 201, as the virtualized data storage area identifier 1552 of the chosen record entry. As the block number range 1554 of the chosen record entry, the CPU 610 of the management computer 600 stores a range that covers all blocks contained in the real data storage area 201. As the LU number 1551 of the chosen record entry, the CPU 610 of the management computer 600 stores “1”, which is an LU number assigned to the virtualized data storage area 101.

Next, the CPU 610 of the management computer 600 chooses a record entry of the mapping information 155 whose real data storage area identifier 1553 matches the identifier of the real data storage area 202. The CPU 610 of the management computer 600 next stores the identifier of the virtualized data storage area 101 as the virtualized data storage area identifier 1552 of the chosen record entry. As the block number range 1554 of the chosen record entry, the CPU 610 of the management computer 600 stores a range that covers all blocks contained in the real data storage area 202. As the LU number 1551 of the chosen record entry, the CPU 610 of the management computer 600 stores “1”, which is an LU number assigned to the virtualized data storage area 101.

Next, the CPU 610 of the management computer 600 chooses a record entry of the mapping information 155 whose real data storage area identifier 1553 matches the identifier of the real data storage area 203. The CPU 610 of the management computer 600 divides the chosen record. entry into two, an upper record entry and a lower record entry.

Next, the CPU 610 of the management computer 600 stores the identifier of the virtualized data storage area 102 as the virtualized data storage area identifier 1552 of the upper record entry. As the block number range 1554 of the upper record entry, the CPU 610 of the management computer 600 stores a range that covers the first half of blocks contained in the real data storage area 203. As the LU number 1551 of the upper record entry, the CPU 610 of the management computer 600 stores “2”, which is an LU number assigned to the virtualized data storage area 102.

Next, the CPU 610 of the management computer 600 stores the identifier of the virtualized data storage area 103 as the virtualized data storage area identifier 1552 of the lower record entry. As the block number range 1554 of the lower record entry, the CPU 610 of the management computer 600 stores a range that covers the second half of blocks contained in the real data storage area 203. As the LU number 1551 of the lower record entry, the CPU 610 of the management computer 600 stores “3”, which is an LU number assigned to the virtualized data storage area 103.

In this way, the CPU 610 of the management computer 600 updates the mapping information 155 shown in FIG. 9A to the mapping information 155 shown in FIG. 9B. The CPU 610 of the management computer 600 sends the mapping information 155 updated as shown in FIG. 9B to the virtualization apparatus 100.

The CPU 140 of the virtualization apparatus 100 updates the mapping information (FIG. 9A) stored in the memory 150 with the mapping information (FIG. 9B) received from the management computer 600. The CPU 140 of the virtualization apparatus 100 thus builds virtualized data storage areas.

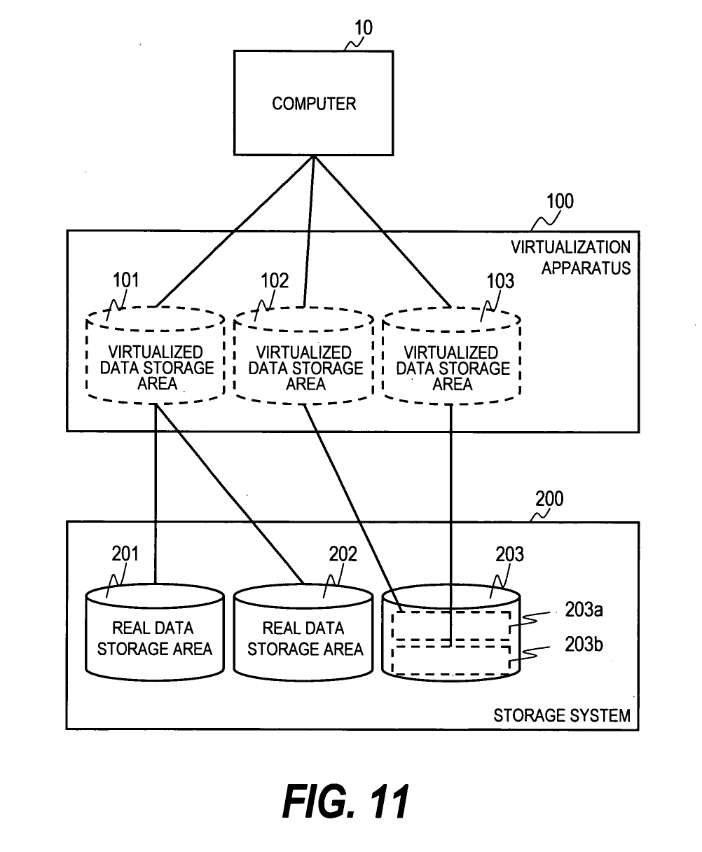

FIG. 11 is an explanatory diagram of the virtualized data storage areas 101 to 103 which are provided by the virtualization apparatus 100 according to the first embodiment of this invention.

The virtualization apparatus 100 provides the virtualized data storage areas 101 to 103 to the computer 10. The virtualized data storage area 101 corresponds to the real data storage areas 201 and 202. The real data storage area 201 is composed of 10000 blocks. Similarly, the real data storage area 202 is composed of 10000 blocks. The size of each block is, for example, 512 bytes.

Blocks in the first half of the virtualized data storage area 101 (block numbers “0” to “9999”) correspond to the real data storage area 201. Blocks in the second half of the virtualized data storage area 101 (block numbers “10000” to “19999”) correspond to the real data storage area 202.

The virtualized data storage areas 102 and 103 correspond to the real data storage area 203 of the storage system 200. The real data storage area 203 is composed of 20000 blocks.

The virtualized data storage area 102 corresponds to a group of blocks that are in the first half of the real data storage area 203 (a block group 203A, block numbers “0” to “9999”). The virtualized data storage area 103 corresponds to a group of blocks that are in the second half of the real data storage area 203 (a block group 203B, block numbers “10000” to “19999”).

Described next is data storage area recognition processing, which is executed by the computer 10.

The CPU 11 of the computer 10 first sends to the virtualization apparatus 100 an Inquiry command containing an LU number “1”. In other words, the CPU 11 of the computer 10 sends to the virtualization apparatus 100 an Inquiry command that is directed to an LU identified by the LU number “1”. The term Inquiry command refers to a command to recognize the existence of a data storage area.

The Inquiry command is received by the CPU 140 of the virtualization apparatus 100. The CPU 140 of the virtualization apparatus 100 executes the inquiry responding program 151 to process the received Inquiry command.

Specifically, the CPU 140 of the virtualization apparatus 100 chooses a record entry of the mapping information 155 whose LU number 1551 matches the LU number “1” contained in the Inquiry command. Then the CPU 140 of the virtualization apparatus 100 judges whether or not a value has been stored as the virtualized data storage area identifier 1552 in the chosen record entry.

In the case where the chosen record entry has no value as the virtualized data storage area identifier 1552, it means that a virtualized data storage area associated with the LU number “1” has not been defined. The CPU 140 of the virtualization apparatus 100 accordingly sends to the computer 10 a response containing a message “no data storage area”.

In the case where the chosen record entry has a value as the virtualized data storage area identifier 1552, on the other hand, the virtualized data storage area 101, which is associated with the LU number “1”, has been defined. The CPU 140 of the virtualization apparatus 100 accordingly extracts the virtualized data storage area identifier 1552 from the chosen record entry, and sends to the computer 10 a response containing the extracted virtualized data storage area identifier 1552.

The response containing the virtualized data storage area identifier 1552 is received by the CPU 11 of the computer 10. The CPU 11 of the computer 10 chooses a record entry of the data storage area identification information table 17 whose LU number 171 matches the LU number “1” contained in the Inquiry command sent. The CPU 11 of the computer 10 stores, as the data storage area identification information 172 of the chosen word entry, the virtualized data storage area identifier 1552 that is contained in the received response.

The CPU 11 of the computer 10 next sends to the virtualization apparatus 100 a Read Capacity command containing the LU number “1”. The term Read Capacity command refers to a command to recognize the capacity of a data storage area.

The Read Capacity command is received by the CPU 140 of the virtualization apparatus 100. Receiving the command, the CPU 140 of the virtualization apparatus 100 chooses a record entry of the mapping information 155 whose LU number 1551 matches the LU number “1” contained in the Read Capacity command.

The CPU 140 of the virtualization apparatus 100 extracts the real data storage area block count 1555 from the chosen record entry.

Then the CPU 140 of the virtualization apparatus 100 sends to the computer 10 a response containing the extracted real data storage area block count 1555.

The response containing the real data storage area block count 1555 is received by the CPU 11 of the computer 10. The CPU 11 of the computer 10 chooses a record entry of the data storage area identification information table 17 whose LU number 171 matches the LU number “1” contained in the Read Capacity command sent. The CPU 11 of the computer 10 stores, as the block count 173 of the chosen record entry, the real data storage area block count 1555 that is contained in the received response.

Similarly, the CPU 11 of the computer 10 sends an Inquiry command containing an LU number “2” and an Inquiry command containing an LU number “3” to the management computer 14 in order. The CPU 11 of the computer 10 then updates the data storage area identification information table 17.

The CPU 11 of the computer 10 next sends an Inquiry command containing an LU number “4” to the management computer 14.

The Inquiry command is received by the CPU 140 of the virtualization apparatus 100. The CPU 140 of the virtualization apparatus 100 chooses a record entry of the mapping information 155 whose LU number 1551 matches the LU number “4” contained in the received Inquiry command. Then the CPU 140 of the virtualization apparatus 100 judges whether or not a value has been stored as the virtualized data storage area identifier 1552 in the chosen record entry.

In this example, the chosen record entry has no value as the virtualized data storage area identifier 1552, which means that a virtualized data storage area associated with the LU number “4” has not been defined. The CPU 140 of the virtualization apparatus 100 accordingly sends to the computer 10 a response containing a message “no data storage area”.

The response containing a message “no data storage area” is received by the CPU 11 of the computer 10. This stops the CPU 11 of the computer 10 to issue Inquiry commands for LUs identified by LU numbers “5” and larger. Then the CPU 11 of the computer 10 ends the data storage area recognition processing.

The CPU 11 of the computer 10 may issue every LU that is identified by an LU number within a specific range. In this case, the CPU 11 of the computer 10 ends the data storage area recognition processing after issuing an Inquiry command to every LU that is identified by an LU number within a specific range.

The description given next is about processing of the read write request modification program 152, which is stored in the memory 150 of the virtualization apparatus 100.

The CPU 11 of the computer 10 sends a read request to the virtualization apparatus 100 in order to obtain data stored in a virtualized data storage area of the virtualization apparatus 100.

Receiving the read request from the computer 10, the CPU 140 of the virtualization apparatus 100 executes the read write request modification program 152. This causes the CPU 140 of the virtualization apparatus 100 to modify data storage area identifier and block position information that are contained in the read request based on the mapping information 155. The CPU 140 of the virtualization apparatus 100 sends the modified read request to the storage system 200.

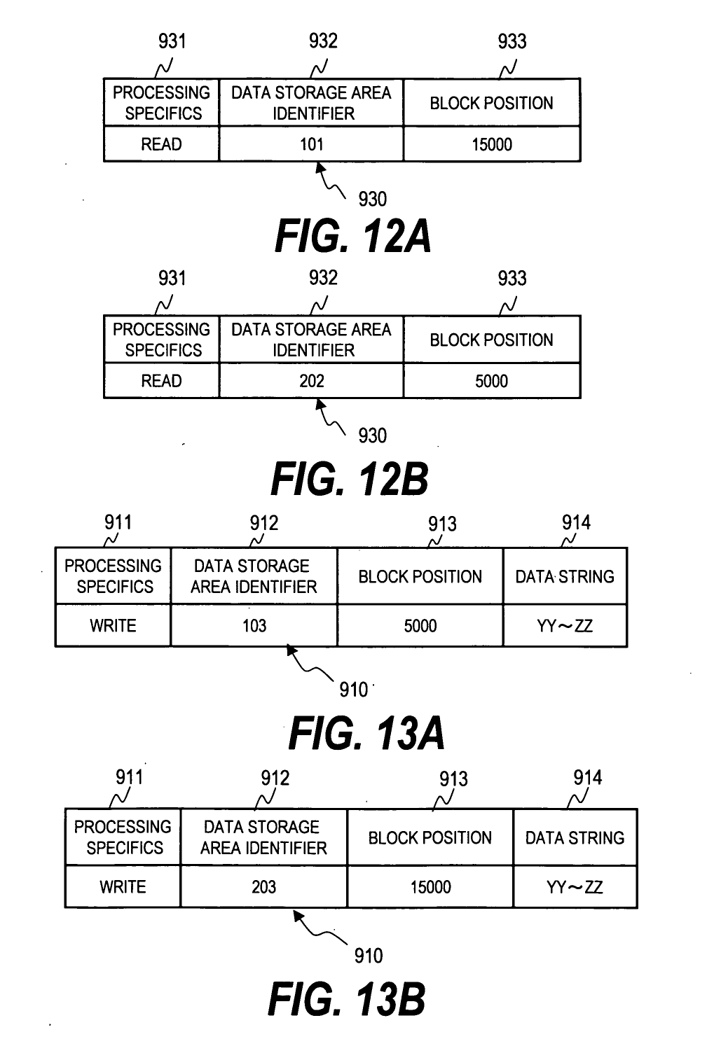

FIG. 12A is an explanatory diagram of a read request 930 which is issued by the computer 10 according to the first embodiment of this invention.

The read request 930 contains processing specifics 931, a data storage area identifier 932 and a block position 933.

What is requested by this particular request is stored as the processing specifics 931. In FIG. 12A, which illustrates a read request, “read” is stored as the processing specifics 931.

The data storage area identifier 932 indicates the identifier of a data storage area where data requested to be read is stored. The block position 933 indicates the address of a block where the data requested to be read is stored.

The read request 930 in FIG. 12A requests reading of data stored in a block identified by a block number “15000” within the virtualized data storage area 101.

The read request 930 is received by the CPU 140 of the virtualization apparatus 100, which upon reception executes the read write request modification program 152. The CPU 140 of the virtualization apparatus 100 modifies the data storage area identifier 932 and the block position 933 that are contained in the read request 930 by consulting the mapping information 155.

Specifically, the CPU 140 of the virtualization apparatus 100 chooses a record entry of the mapping information 155 whose virtualized data storage area identifier 1552 matches “101”, which is contained as the data storage area identifier 932 in the read request 930.

The CPU 140 of the virtualization apparatus 100 extracts, from the chosen record entry, in order from top to bottom, values registered as the block count 1555. In this example, the CPU 140 of the virtualization apparatus 100 first extracts “10000” as the block count 1555 and then extracts “10000” as the block count 1555.

Next, the CPU 140 of the virtualization apparatus 100 subtracts the values extracted as the block count 1555 from “15000” as the block position 933 of the read request 930 until immediately before the result turns into a negative value. The CPU 140 of the virtualization apparatus 100 thus obtains “5000” as the block position 933 after modification.

The CPU 140 of the virtualization apparatus 100 next identifies which record entry of the mapping information 155 has the block count 155 that is subtracted last. From a record entry that immediately follows the identified record entry, the CPU 140 of the virtualization apparatus 100 extracts “202” as the real data storage area identifier 1553. The CPU 140 of the virtualization apparatus 100 sets the extracted real data storage area identifier 1553, namely, “202”, as the data storage area identifier 932 after modification.

In this way, the CPU 140 of the virtualization apparatus 100 modifies the read request 930 shown in FIG. 12A into a read request that is shown in FIG. 12B.

FIG. 12B is an explanatory diagram of the read request 930 that is modified by the virtualization apparatus 100 according to the first embodiment of this invention.

The read request 930 of FIG. 12B requests reading of data stored in a block identified by a block number “5000” within the real data storage area 202. The CPU 140 of the virtualization apparatus 100 sends the modified read request 930 to the storage system 200. In response to this read request 930, the CPU 140 of the virtualization apparatus 100 receives from the storage system 200 data stored in a block identified by a block number “5000” within the real data storage area 202.

The CPU 140 of the virtualization apparatus 100 sends the received data to the computer 10. The CPU 11 of the computer 10 can thus read data out of the virtualized data storage area 101 of the virtualization apparatus 100 without recognizing the real data storage areas 201 and 202, which correspond to the virtualized data storage area 101.

To store data in a virtualized data storage area of the virtualization apparatus 100, the CPU 11 of the computer 10 sends a write request to the virtualization apparatus 100.

Receiving the write request from the computer 10, the CPU 140 of the virtualization apparatus 100 executes the read write request modification program 152. The CPU 140 of the virtualization apparatus 100 modifies data storage area identifier and block position information that are contained in the write request based on the mapping information 155. The CPU 140 of the virtualization apparatus 100 sends the modified write request to the storage system 200.

FIG. 13A is an explanatory diagram of a write request 910 which is issued by the computer 10 according to the first embodiment of this invention.

The write request 910 contains processing specifics 911, a data storage area identifier 912, a block position 913, and a data string 914.

What is requested by this particular request is stored as the processing specifics 911. In FIG. 13A, which illustrates a write request, “write” is stored as the processing specifics 911.

The data storage area identifier 912 indicates the identifier of a data storage area where data requested to be written is stored. The block position 913 indicates the address of a block where the data requested to be written is stored. The data string 914 indicates the data requested to be written.

The write request 910 in FIG. 13A requests writing of data of “YY to ZZ” to a block identified by a block number “5000” within the virtualized data storage area 103.

The write request 910 is received by the CPU 140 of the virtualization apparatus 100, which upon reception executes the read write request modification program 152. This causes the CPU 140 of the virtualization apparatus 100 to modify the data storage area identifier 912 and the block position 913 that are contained in the write request 910 by consulting the mapping information 155.

Specifically, the CPU 140 of the virtualization apparatus 100 chooses a record entry of the mapping information 155 whose virtualized data storage area identifier 1552 matches “103”, which is contained as the data storage area identifier 912 in the write request 910.

From the chosen record entry, the CPU 140 of the virtualization apparatus 100 extracts “203” as the real data storage area identifier 1553 and “10000 to 19999” as the real data storage area block number range 1554.

The CPU 140 of the virtualization apparatus 100 sets the extracted real data storage area identifier 1553, namely, “203”, as the data storage area identifier 912 after modification.

The CPU 140 of the virtualization apparatus 100 next adds “5000”, which is contained as the block position 913 in the write request 910, to “10000”, which is the head value of the extracted block number range 1554. The CPU 140 of the virtualization apparatus 100 thus obtains “15000” as the block position 913 after modification.

In this way, the CPU 140 of the virtualization apparatus 100 modifies the write request 910 shown in FIG. 13A into a write request that is shown in FIG. 13B.

FIG. 13B is an explanatory diagram of the write request 910 that is modified by the virtualization apparatus 100 according to the first embodiment of this invention.

The write request 910 of FIG. 13B requests writing of data of “YY to ZZ” to a block identified by a block number “15000” within the real data storage area 203.

The CPU 140 of the virtualization apparatus 100 sends the modified write request 910 to the storage system 200. In response to this write request 910, the CPU 140 of the virtualization apparatus 100 receives from the storage system 200 a response containing a message “writing completed”.

The CPU 140 of the virtualization apparatus 100 sends the received response to the computer 10. The CPU 11 of the computer 10 can thus write data to the virtualized data storage area 103 of the virtualization apparatus 100 without recognizing the real data storage area 203 which corresponds to the virtualized data storage area 103.

Described next is backup processing of the backup computer 500.

The CPU 540 of the backup computer 500 receives a backup request from the backup request issuing program 16 of the computer 10 or from the backup request issuing program 651 of the management computer 600, and executes the backup program 551 upon reception of the request.

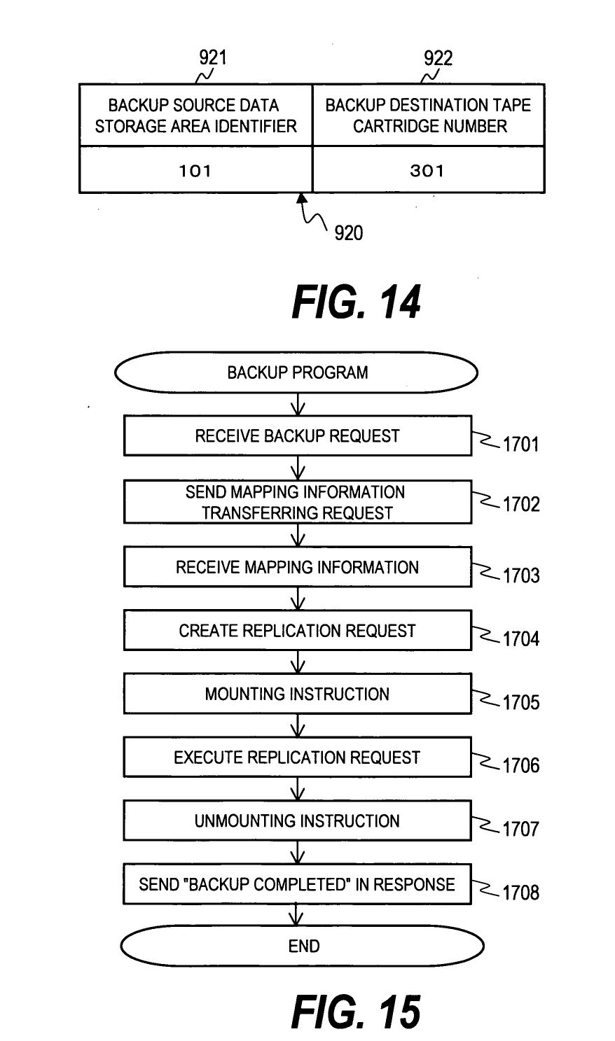

Backup processing of when a backup request received by the CPU 540 of the backup computer 500 is as shown in FIG. 14 will be described first.

FIG. 14 is an explanatory diagram of a backup request 920 according to the first embodiment of this invention.

The backup request 920 contains a backup source data storage area identifier 921 and a backup destination tape cartridge number 922.

The backup source data storage area identifier 921 indicates an identifier unique to a virtualized data storage area that stores data requested to be backed up. In short, the backup source data storage area identifier 921 indicates the identifier of a virtualized data storage area that is the backup source. The backup destination tape cartridge number 922 indicates an identifier unique to one of the tape cartridges 301 to 303 that stores backup data of the virtualized data storage area identified by the backup source data storage area identifier 921. In short, the backup destination tape cartridge number 922 indicates an identifier unique to one of the tape cartridges 301 to 303 that is the destination of backup data transferred.

The backup request 920 of FIG. 14 requests to back up data of the virtualized data storage area 101 to the tape cartridge 301 of the tape library device 300. The tape cartridges 301 to 303 of the tape library device 300 have enough storage capacity to store backup data of the virtualized data storage area 101.

FIG. 15 is a flow chart for backup processing of the backup computer 500 according to the first embodiment of this invention.

The CPU 540 of the backup computer 500 first receives the backup request 920 from the backup request issuing program 16 of the computer 10 or from the backup request issuing program 651 of the management computer 600 (1701).

Receiving the request, the CPU 540 of the backup computer 500 sends a mapping information transferring request to the virtualization apparatus 100 (1702).

The mapping information transferring request is received by the CPU 140 of the virtualization apparatus 100. The CPU 140 of the virtualization apparatus 100 sends the mapping information 155 stored in the memory 150 to the backup computer 500.

The CPU 540 of the backup computer 500 receives the mapping information 155 (1703). The CPU 540 of the backup computer 500 stores the received mapping information 155 in the mapping information holding area 555 of the memory 550.

The mapping information 155 stored in the mapping information holding area 555 is consulted by the CPU 540 of the backup computer 500 in creating a replication request based on the backup request that has been received in Step 1701 (1704).

Specifically, the CPU 540 of the backup computer 500 chooses a record entry of the mapping information 155 whose virtualized data storage area identifier 1552 matches “101” contained as the backup source data storage area identifier 921 in the backup request 920. The CPU 540 of the backup computer 500 extracts from the chosen record entry the real data storage area identifier 1553 and the real data storage area block number range 1554. In this example, the CPU 540 of the backup computer 500 extracts a combination of “201” as the real data storage area identifier 1553 and “0 to 9999” as the real data storage area block number range 1554, and a combination of “202” as the real data storage area identifier 1553 and “0 to 9999” as the real data storage area block number range 1554.

The CPU 540 of the backup computer 500 then creates a replication request from the extracted real data storage area identifier 1553 and real data storage area block number range 1554. In this example, the CPU 540 of the backup computer 500 creates a first replication request and a second replication request. Specifically, the CPU 540 of the backup computer 500 creates the first replication request from the combination of “201” as the real data storage area identifier 1553 and “0 to 9999” as the real data storage area block number range 1554, and creates the second replication request from the combination of “202” as the real. data storage area identifier 1553 and “0 to 9999” as the real data storage area block number range 1554.

The first replication request requests to copy, to the tape cartridge 301, data of blocks identified by block numbers “0 to 9999” within the real data storage area 201. The second replication request requests to copy, to the tape cartridge 301, data of blocks identified by block numbers “0 to 9999” within the real data storage area 202.

The CPU 540 of the backup computer 500 next extracts “301” as the backup destination tape cartridge number 922 from the backup request 920 received in Step 1701. The CPU 540 of the backup computer 500 instructs the tape library device 300 to mount the tape cartridge 301, which is designated by the extracted backup destination tape cartridge number 922, “301” (1705).

The instruction to mount the tape cartridge 301 is received by the CPU 340 of the tape library device 300. The CPU 340 of the tape library device 300 mounts the tape cartridge 301 to the tape device 320 by controlling the tape cartridge handling mechanism 330. Then the CPU 340 of the tape library device 300 sends a message “mounting completed” to the backup computer 500 in response.

Receiving the message “mounting completed”, the CPU 540 of the backup computer 500 executes the replication requests created in Step 1704. The CPU 540 of the backup computer 500 implements the replication requests by executing the data transmission program 552. In the case where plural replication requests are created in Step 1704, the CPU 540 of the backup computer 500 executes the replication requests in order.

Specifically, the CPU 540 of the backup computer 500 executes the first replication request created (1706). As a result, data of blocks identified by block numbers “0 to 9999” within the real data storage area 201 is copied by the CPU 540 of the backup computer 500 to the first half data storage area of the tape cartridge 301.

The CPU 540 of the backup computer 500 next executes the second replication request created. As a result, data of blocks identified by block numbers “0 to 9999” within the real data storage area 202 is copied by the CPU 540 of the backup computer 500 to the second half data storage area of the tape cartridge 301.

After finishing executing every replication request that is created in Step 1704, the CPU 540 of the backup computer 500 instructs the tape library device 300 to unmount the tape cartridge 301 (1707).

The instruction to unmount the tape cartridge 301 is received by the CPU 340 of the tape library device 300. The CPU 340 of the tape library device 300 unmounts the tape cartridge 301 from the tape device 320 by controlling the tape cartridge handling mechanism 330. Then the CPU 340 of the tape library device 300 sends a message “unmounting completed” to the backup computer 500 in response.

Receiving the message “unmounting completed”, the CPU 540 of the backup computer 500 sends a message “backup completed” to the computer 10 or the management computer 600 in response (1708). The CPU 540 of the backup computer 500 then ends the backup processing.

As described above, the CPU 540 of the backup computer 500 creates a replication request based on a backup request, and executes the created replication request. This enables the computer system of this embodiment to back up data of the virtualized data storage area 101, which is provided by the virtualization apparatus 100, to the tape cartridge 301, which is located in the tape library device 300, without sending backup data to the virtualization apparatus 100. The computer system of this embodiment can therefore lessen the load on the virtualization apparatus 100 during backup processing.

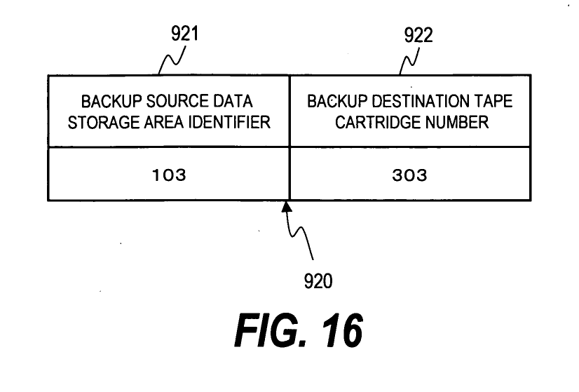

Backup processing of when a backup request received by the CPU 540 of the backup computer 500 is as shown in FIG. 16 will be described next.

FIG. 16 is an explanatory diagram of the backup request 920 according to the first embodiment of this invention.

The backup request 920 contains the backup source data storage area identifier 921 and the backup destination tape cartridge number 922.

The backup source data storage area identifier 921 and the backup destination tape cartridge number 922 are the same as those contained in the backup request that has been described with reference to FIG. 14, and their descriptions will be omitted here.

The backup request 920 of FIG. 16 requests to back up data of the virtualized data storage area 103 to the tape cartridge 303 of the tape library device 300.

How the backup computer 500 processes this backup request 920 will be described with reference to FIG. 15.

The CPU 540 of the backup computer 500 first receives the backup request 920 from the backup request issuing program 16 of the computer 10 or from the backup request issuing program 651 of the management computer 600 (1701).

Receiving the request, the CPU 540 of the backup computer 500 sends a mapping information transferring request to the virtualization apparatus 100 (1702).

The mapping information transferring request is received by the CPU 140 of the virtualization apparatus 100. The CPU 140 of the virtualization apparatus 100 sends the mapping information 155 stored in the memory 150 to the backup computer 500.

The CPU 540 of the backup computer 500 receives the mapping information 155 (1703). The CPU 540 of the backup computer 500 stores the received mapping information 155 in the mapping information holding area 555 of the memory 550.

The mapping information 155 stored in the mapping information holding area 555 is consulted by the CPU 540 of the backup computer 500 in creating a replication request based on the backup request that has been received in Step 1701 (1704).

Specifically, the CPU 540 of the backup computer 500 chooses a record entry of the mapping information 155 whose virtualized data storage area identifier 1552 matches “103” contained as the backup source data storage area identifier 921 in the backup request 920. The CPU 540 of the backup computer 500 extracts from the chosen record entry the real data storage area identifier 1553 and the real data storage area block number range 1554. In this example, the CPU 540 of the backup computer 500 extracts “203” as the real data storage area identifier 1553 and “10000 to 19999” as the real data storage area block number range 1554.

The CPU 540 of the backup computer 500 then creates a replication request from the extracted real data storage area identifier 1553 and real data storage area block number range 1554, namely, “203” and “10000 to 19999”. This replication request requests to copy, to the tape cartridge 303, data of blocks identified by block numbers “10000 to 19999” within the real data storage area 203.

The CPU 540 of the backup computer 500 next extracts “303” as the backup destination tape cartridge number 922 from the backup request 920 received in Step 1701. The CPU 540 of the backup computer 500 instructs the tape library device 300 to mount the tape cartridge 303, which is designated by the extracted backup destination tape cartridge number 922, “303” (1705).

The instruction to mount the tape cartridge 303 is received by the CPU 340 of the tape library device 300. The CPU 340 of the tape library device 300 mounts the tape cartridge 303 to the tape device 320 by controlling the tape cartridge handling mechanism 330. Then the CPU 340 of the tape library device 300 sends a message “mounting completed” to the backup computer 500 in response.

Receiving the message “mounting completed”, the CPU 540 of the backup computer 500 executes the replication request created in Step 1704 (1706). The CPU 540 of the backup computer 500 implements the replication request by executing the data transmission program 552. In this way, the CPU 540 of the backup computer 500 copies to the tape cartridge 303 data of blocks identified by block numbers “10000 to 19999” within the real data storage area 203.

Next, the CPU 540 of the backup computer 500 instructs the tape library device 300 to unmount the tape cartridge 303 (1707).

The instruction to unmount the tape cartridge 303 is received by the CPU 340 of the tape library device 300. The CPU 340 of the tape library device 300 unmounts the tape cartridge 303 from the tape device 320 by controlling the tape cartridge handling mechanism 330. Then the CPU 340 of the tape library device 300 sends a message “unmounting completed” to the backup computer 500 in response.

Receiving the message “unmounting completed”, the CPU 540 of the backup computer 500 sends a message “backup completed” to the computer 10 or the management computer 600 in response (1708). The CPU 540 of the backup computer 500 then ends the backup processing.

Now, effects of the first embodiment of this invention will be described.

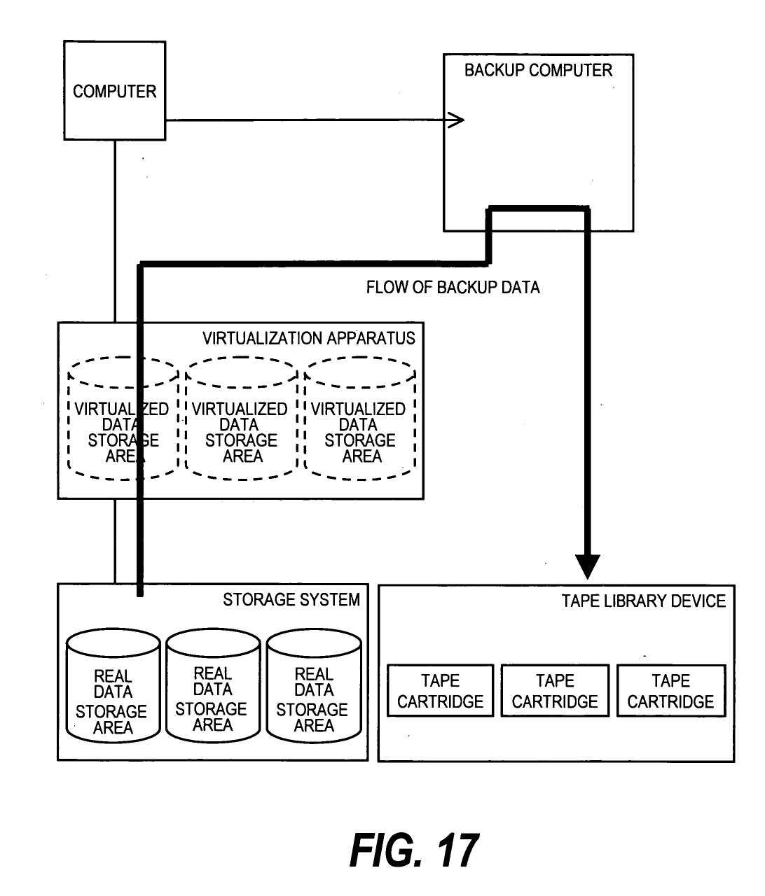

FIG. 17 is an explanatory diagram of a flow of backup data in a computer system that executes backup processing in a virtualized environment.

FIG. 17 shows a mode of a computer system that executes backup processing in a virtualized environment through a method different from that of the computer system according to the first embodiment of this invention.

The association between a virtualized data storage area of a virtualization apparatus and a real data storage area of a storage system is not information available to a backup computer provided in a computer system that executes backup processing in a virtualized environment. Accordingly, in backing up data of a virtualized data storage area in the virtualization apparatus, the backup computer receives backup data of this virtualized data storage area from the virtualization apparatus. In short, backup data passes through a virtualization apparatus in a computer system that executes backup processing in a virtualized environment. This means that the load of backup processing is applied to the virtualization apparatus.

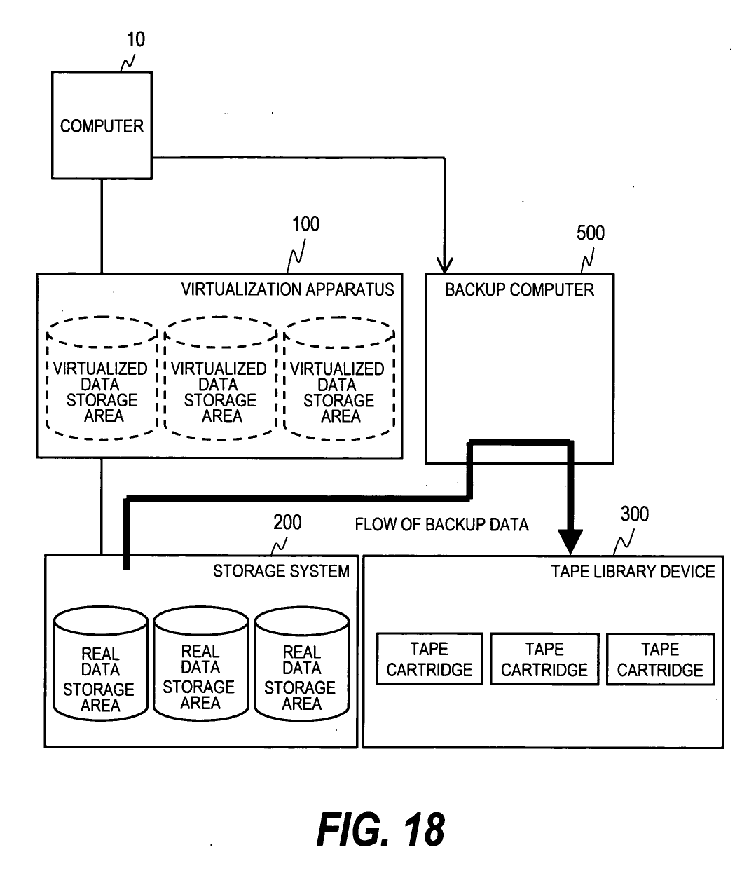

FIG. 18 is an explanatory diagram of a flow of backup data in the computer system according to the first embodiment of this invention.

The backup computer 500 of this embodiment checks the association between virtualized data storage areas of the virtualization apparatus 100 and the real data storage areas 201 to 203 of the storage system 200 to create a replication request. The backup computer 500 executes the created replication request, thereby obtaining backup data directly from the storage system 20. Accordingly, backup data does not pass through the virtualization apparatus 100 in the computer system of this embodiment. This enables the computer system of this embodiment to lessen the load on the virtualization apparatus 100 during backup processing.

The description given next is about restoration processing of the backup computer 500.

The CPU 540 of the backup computer 500 receives a restoration request from the backup request issuing program 16 of the computer 10 or from the backup request issuing program 651 of the management computer 600, and executes the backup program 551 upon reception of the request.

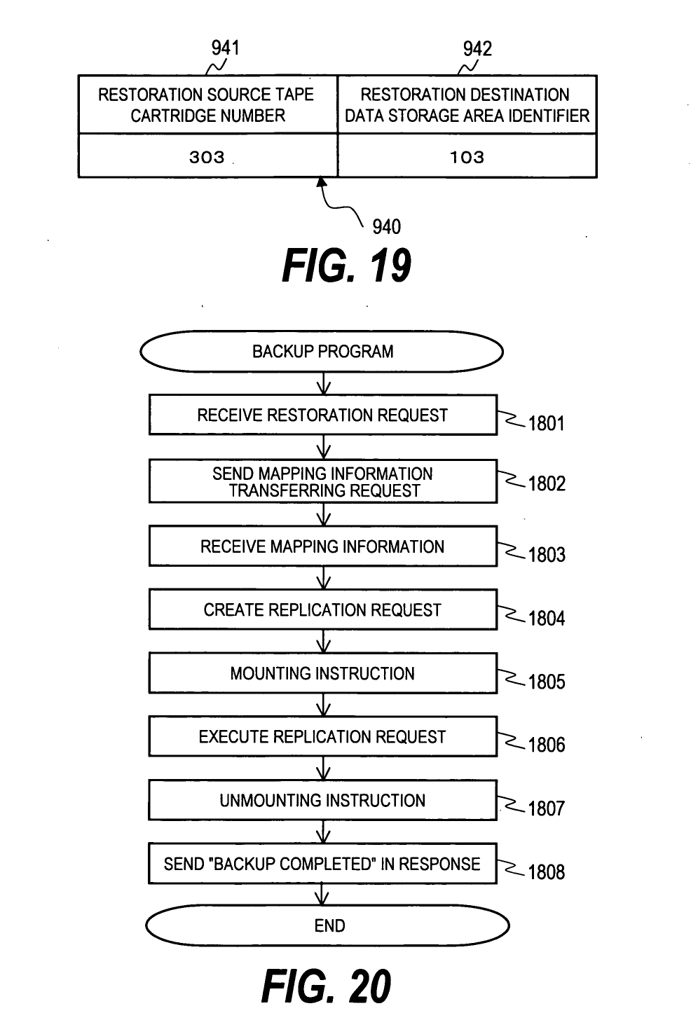

Described here is restoration processing of when a restoration request received by the CPU 540 of the backup computer 500 is as shown in FIG. 19.

FIG. 19 is an explanatory diagram of a restoration request 940 according to the first embodiment of this invention.

The restoration request 940 contains a restoration source tape cartridge number 941 and a restoration destination data storage area identifier 942.

The restoration source tape cartridge number 941 indicates an identifier unique to one of the tape cartridges 301 to 303 that stores restoration data. The restoration destination data storage area identifier 942 indicates an identifier unique to a virtualized data storage area requested to be restored.

The restoration request 940 of FIG. 19 requests to restore the virtualized data storage area 103 of the virtualization apparatus 100 with data stored in the tape cartridge 303 of the tape library device 300.

FIG. 20 is a flow chart for restoration processing of the backup computer 500 according to the first embodiment of this invention.

The CPU 540 of the backup computer 500 first receives the backup request 940 from the backup request issuing program 16 of the computer 10 or from the backup request issuing program 651 of the management computer 600 (1801).

Receiving the request, the CPU 540 of the backup computer 500 sends a mapping information transferring request to the virtualization apparatus 100 (1802).

The mapping information transferring request is received by the CPU 140 of the virtualization apparatus 100. The CPU 140 of the virtualization apparatus 100 sends the mapping information 155 stored in the memory 150 to the backup computer 500.

The CPU 540 of the backup computer 500 receives the mapping information 155 (1803). The CPU 540 of the backup computer 500 stores the received mapping information 155 in the mapping information holding area 555 of the memory 550.

The mapping information 155 stored in the mapping information holding area 555 is consulted by the CPU 540 of the backup computer 500 in creating a replication request based on the restore request that has been received in Step 1801 (1804).

Specifically, the CPU 540 of the backup computer 500 chooses a record entry of the mapping information 155 whose virtualized data storage area identifier 1552 matches “103” contained as the restore destination data storage area identifier 942 in the restore request 940. The CPU 540 of the backup computer 500 extracts from the chosen record entry the real data storage area identifier 1553 and the real data storage area block number range 1554. In this example, the CPU 540 of the backup computer 500 extracts “203” as the real data storage area identifier 1553 and “10000 to 19999” as the real data storage area block number range 1554.

The CPU 540 of the backup computer 500 then creates a replication request from the extracted real data storage area identifier 1553 and real data storage area block number range 1554. Specifically, the CPU 540 of the backup computer 500 creates a replication request from “203”, the real data storage area identifier 1553, and “10000 to 19999”, the real data storage area block number range 1554. This replication request requests to copy data stored in the tape cartridge 303 to blocks identified by block numbers “10000 to 19999” within the real data storage area 203.

The CPU 540 of the backup computer 500 next extracts “303” as the restoration destination tape cartridge number 941 from the restore request 940 received in Step 1801. The CPU 540 of the backup computer 500 instructs the tape library device 300 to mount the tape cartridge 303, which is designated by the extracted restoration destination tape cartridge number 941, “303” (1805).

The instruction to unmount the tape cartridge 303 is received by the CPU 340 of the tape library device 300. The CPU 340 of the tape library device 300 mounts the tape cartridge 303 to the tape device 320 by controlling the tape cartridge handling mechanism 330. Then the CPU 340 of the tape library device 300 sends a message “mounting completed” to the backup computer 500 in response.

Receiving the message “mounting completed”, the CPU 540 of the backup computer 500 executes the replication request created in Step 1804 (1806). As a result, data of the tape cartridge 303 is copied by the CPU 540 of the backup computer 500 to blocks identified by block numbers “10000 to 19999” within the real data storage area 203. The CPU 540 of the backup computer 500 implements the replication request by executing the data transmission program 552. In the case where plural replication requests are created in Step 1804, the CPU 540 of the backup computer 500 executes the replication requests in order.

After finishing executing every replication request that is created in Step 1804, the CPU 540 of the backup computer 500 instructs the tape library device 300 to unmount the tape cartridge 303 (1807).

The instruction to unmount the tape cartridge 303 is received by the CPU 340 of the tape library device 300. The CPU 340 of the tape library device 300 unmounts the tape cartridge 303 from the tape device 320 by controlling the tape cartridge handling mechanism 330. Then the CPU 340 of the tape library device 300 sends a message “unmounting completed” to the backup computer 500 in response.

Receiving the message “unmounting completed”, the CPU 540 of the backup computer 500 sends a message “backup completed” to the computer 10 or the management computer 600 in response (1808). The CPU 540 of the backup computer 500 then ends the restore processing.

Described next is a first modification example of the computer system according to the first embodiment of this invention.

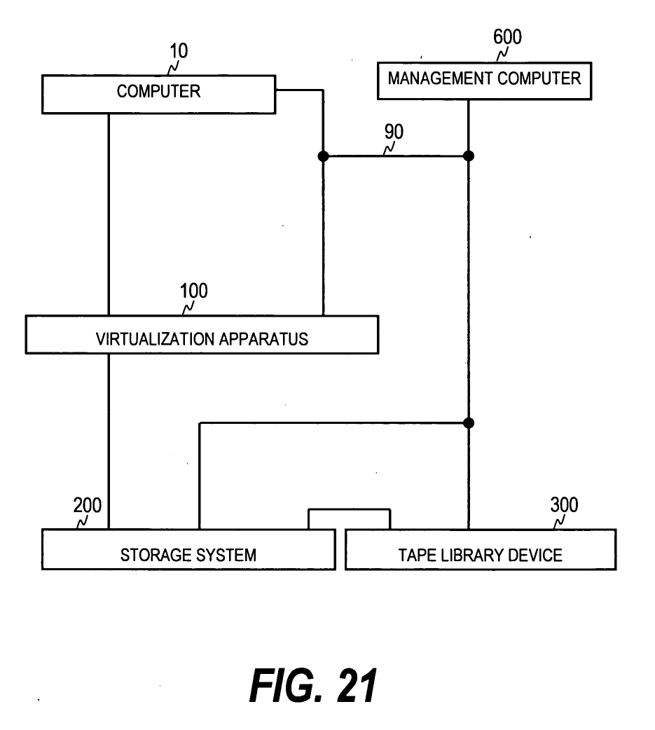

FIG. 21 is a block diagram showing a configuration of a computer system according to the first modification example.

The computer system of the first modification example has the computer 10, the virtualization apparatus 100, the storage system 200, the tape library device 300, and the management computer 600.

In other words, the computer system configuration according to the first modification example does not have the backup computer 500. Also, the storage system 200 and the tape library device 300 in the computer system of the first modification example are connected to each other via a network to which a fibre channel protocol is applied. The rest of the configuration of the computer system according to the first modification example is the same as that of the computer system described with reference to FIG. 1, and its description will therefore be omitted here.

The computer 10, the virtualization apparatus 100, the storage system 200, and the management computer 600 are the same as those in the computer system described with reference to FIG. 1. Accordingly, the descriptions on those components will not be repeated.

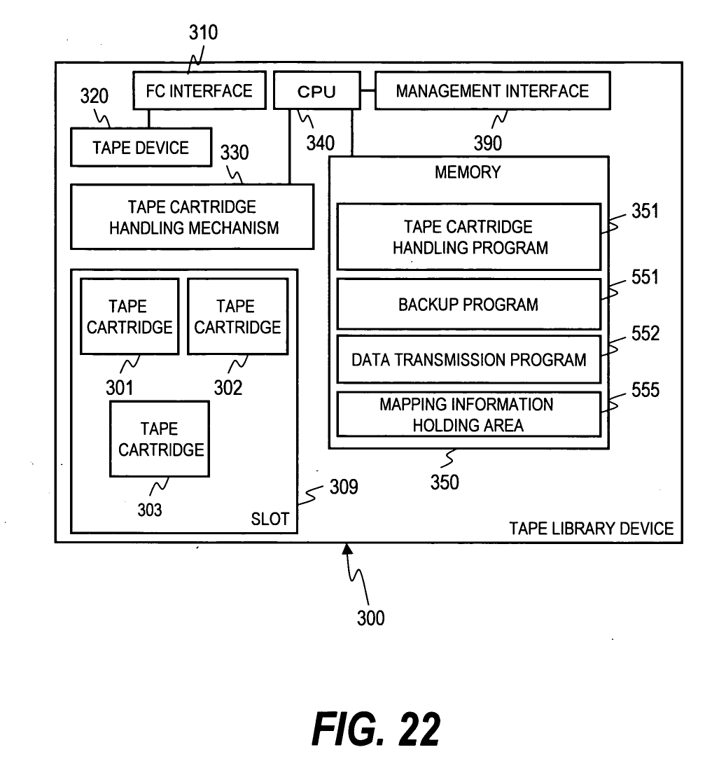

FIG. 22 is a block diagram showing a configuration of the tape library device 300 that is provided in the computer system according to the first modification example.

The memory 350 of the tape library device 300 according to the first modification example stores the backup program 551 and the data transmission program 552. The memory 350 of the tape library device 300 according to the first modification example also contains the mapping information holding area 555. The rest of the configuration of the tape library device 300 according to the first modification example is the same as that of the tape library device described with reference to FIG. 5. Components common to the two are denoted by the same reference numerals to avoid repeating the description.

The backup program 551, the data transmission program 552, and the mapping information holding area 555 are the same as those stored in the memory 550 of the backup computer 500 that has been described with reference to FIG. 6. Accordingly, the descriptions on those programs and information will not be repeated.

Instead of having the backup computer 500, the computer system of the first modification example gives the tape library device 300 the same function as the backup computer 500. Accordingly, in the computer system of the first modification example, the tape library device 300 controls backup and data transmission in place of the backup computer 500. This enables the computer system of the first modification example to execute backup processing and restoration processing without burdening the virtualization apparatus 100.

Described next is a second modification example of the computer system according to the first embodiment of this invention.

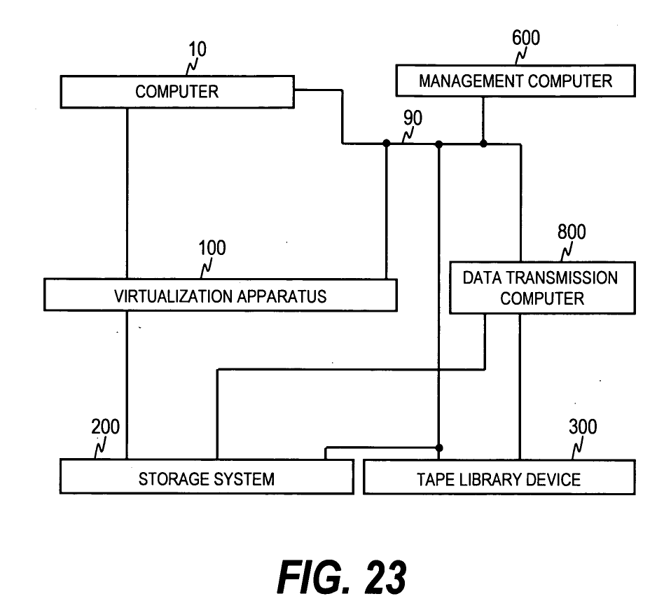

FIG. 23 is a block diagram showing a configuration of a computer system according to the second modification example.

The computer system of the second modification example has the computer 10, the virtualization apparatus 100, the storage system 200, the tape library device 300, a data transmission computer 800, and the management computer 600. In short, the computer system of the second modification example has the same configuration as that of the computer system described with reference to FIG. 1 except that the data transmission computer 800 takes place of the backup computer 500.

The data transmission computer 800 controls data transmission between the storage system 200 and the tape library device 300 based on a request received from the virtualization apparatus 100. Alternatively, the computer system of the second modification example may have a fibre channel switch with a data transmission function instead of the data transmission computer 800. It is also possible for the computer system of the second modification example to which an Internet protocol is applied to have an IP switch with a data transmission function instead of the data transmission computer 800.

The computer 10, the storage system 200, the tape library device 300, and the management computer 600 are the same as those in the computer system described with reference to FIG. 1. Accordingly, the descriptions on those components will not be repeated.

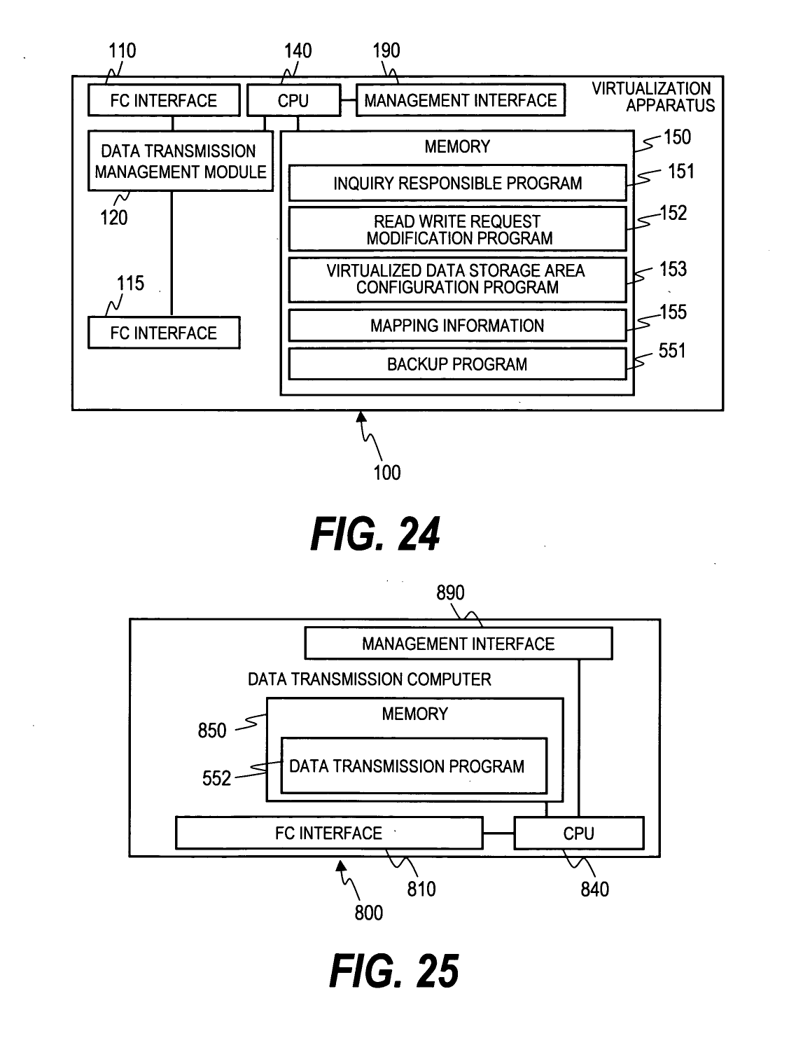

FIG. 24 is a block diagram showing a configuration of the virtualization apparatus 100 that is provided in the computer system according to the second modification example.

The memory 150 of the virtualization apparatus 100 according to the second modification example stores the backup program 551. The rest of the configuration of the virtualization apparatus 100 according to the second modification example is the same as that of the virtualization apparatus described with reference to FIG. 3A. Components common to the two are denoted by the same reference numerals to avoid repeating the description.

The backup program 551 is the same as the one stored in the memory 550 of the backup computer 500 that has been described with reference to FIG. 6. A description on the program will therefore be omitted here.

FIG. 25 is a block diagram showing a configuration of the data transmission computer 800 that is provided in the computer system according to the second modification example.

The data transmission computer 800 has an FC interface 810, a CPU 840, a memory 850, and a management interface 890.

The FC interface 810 is connected to the storage system 200 and tape library device 300 via a network to which a fibre channel protocol is applied. The management interface 890 is connected to the computer 100, virtualization apparatus 100, and the management computer 600 via the management network 90.

The CPU 840 performs various types of processing by executing programs stored in the memory 850.

The memory 850 stores information including programs that are executed by the CPU 840. Specifically, the memory 850 stores the data transmission program 552. The data transmission program 552 stored in the memory 850 is the same as the one stored in the memory 550 of the backup computer 500 which has been described with reference to FIG. 6. A description on the program will therefore be omitted here.

In the computer system of the second modification example, the virtualization apparatus 100 controls backup in place of the backup computer 500, while the data transmission computer 800 controls data transmission in place of the backup computer 500. This enables the computer system of the second modification example to execute backup processing and restoration processing without sending backup data through the virtualization apparatus 100.

### SECOND EMBODIMENT

A computer system according to a second embodiment of this invention copies data from a backup source real data storage area to another real data storage area, to thereby restore a virtualized data storage area of a virtualization apparatus.

The computer system of the second embodiment has the same configuration as that of the computer system of the first embodiment. The same processing is performed in the computer system of the second embodiment and the computer system of the first embodiment except for restoration processing of FIG. 20. The descriptions on the same configuration and processing will not be repeated.

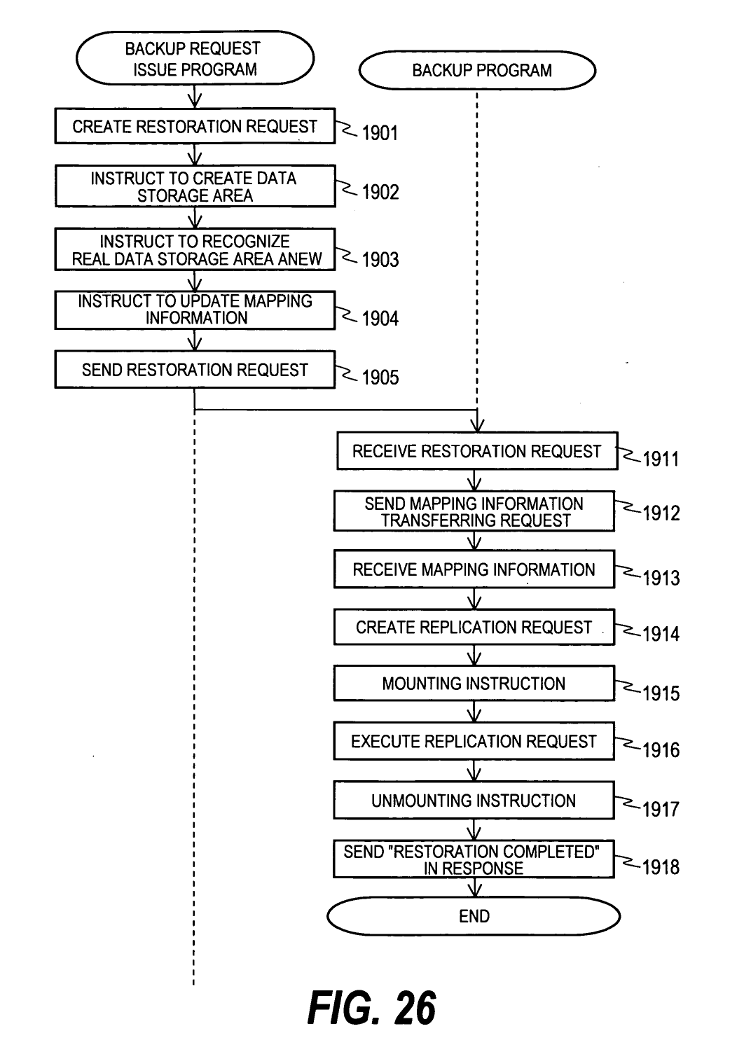

FIG. 26 is a flow chart for restoration processing in the computer system according to the second embodiment of this invention.

As the administrator enters a restoration instruction, the CPU 610 of the management computer 600 executes a backup request issuing program 652.

Specifically, the CPU 610 of the management computer 600 creates the restoration request 940 consulting the data storage area identification information table 17, which is obtained in advance from the computer 10 (1901). In this example, the restoration request created by the CPU 610 of the management computer 600 is as shown in FIG. 19. This restoration request 940 requests to restore the virtualized data storage area 103 of the virtualization apparatus 100 with data stored in the tape cartridge 303 of the tape library device 300.

The CPU 610 of the management computer 600 next instructs the storage system 200 to create a real data storage area that has the same capacity as the virtualized data storage area 103 requested to be restored (1902).

The CPU 240 of the storage system 200 creates a real data storage area having the same capacity as the virtualized data storage area 103 by executing the data storage area management program 251. In this example, the CPU 240 of the storage system 200 creates two real data storage areas 204 and 205. The real data storage areas 204 and 205 each have 5000 blocks.

Then the CPU 610 of the management computer 600 instructs the computer 10 to execute processing of newly recognizing real data storage areas in the storage system 200 (1903).

The CPU 11 of the computer 10 recognizes the real data storage areas 204 and 205 by executing the virtualized data storage area configuration program 153.

The CPU 610 of the management computer 600 next instructs the virtualization apparatus 100 to update the mapping information 155 (1904).

The CPU 140 of the virtualization apparatus 100 updates the mapping information 155 by executing the virtualized data storage area configuration program 153.

Specifically, the CPU 140 of the virtualization apparatus 100 chooses a record entry of the mapping information 155 whose virtualized data storage area identifier 1552 matches the restoration destination data storage area identifier 941 of the restoration request 940 created. The CPU 140 of the virtualization apparatus 100 stores, as the real data storage area identifier 1553 of the chosen record entry, the identifiers of the newly created real data storage areas 204 and 205. As the block number range 1554 of the chosen record entry, the CPU 140 of the virtualization apparatus 100 stores the range of block numbers of blocks that are contained in the newly created real data storage areas 204 and 205. As the block count 1555 of the chosen record entry, the CPU 140 of the virtualization apparatus 100 stores the count of blocks that are contained in the newly created real data storage areas 204 and 205.

The CPU 140 of the virtualization apparatus 100 thus updates the mapping information 155 shown in FIG. 9B to the mapping information 155 shown in FIG. 9C.

Thereafter, the CPU 610 of the management computer 600 sends the restoration request 940 created in Step 1901 to the backup computer 500 (1905).

The restoration request 940 from the management computer 600 is received by the CPU 540 of the backup computer 500 (1911).

Receiving the request, the CPU 540 of the backup computer 500 sends a mapping information transferring request to the virtualization apparatus 100 (1912).

The mapping information transferring request is received by the CPU 140 of the virtualization apparatus 100. The CPU 140 of the virtualization apparatus 100 sends the mapping information 155 of FIG. 9C stored in the memory 150 to the backup computer 500.

The CPU 540 of the backup computer 500 receives the mapping information 155 (1913). The CPU 540 of the backup computer 500 stores the received mapping information 155 in the mapping information holding area 555 of the memory 550.

The mapping information 155 stored in the mapping information holding area 555 is consulted by the CPU 540 of the backup computer 500 in creating a replication request based on the restore request that has been received in Step 1911 (1914).

Specifically, the CPU 540 of the backup computer 500 chooses a record entry of the mapping information 155 whose virtualized data storage area identifier 1552 matches “103” contained as the restore destination data storage area identifier 942 in the restore request 940. The CPU 540 of the backup computer 500 extracts from the chosen record entry the real data storage area identifier 1553 and the real data storage area block number range 1554. In this example, the CPU 540 of the backup computer 500 extracts a combination of “204” as the real data storage area identifier 1553 and “0 to 4999” as the real data storage area block number range 1554, and a combination of “205” as the real data storage area identifier 1553 and “0 to 4999” as the real data storage area block number range 1554.

The CPU 540 of the backup computer 500 then creates a replication request from the extracted real data storage area identifier 1553 and real data storage area block number range 1554. In this example, the CPU 540 of the backup computer 500 creates a first replication request and a second replication request. Specifically, the CPU 540 of the backup computer 500 creates the first replication request from the combination of “204” as the real data storage area identifier 1553 and “0 to 4999” as the real data storage area block number range 1554, and creates the second replication request from the combination of “205” as the real data storage area identifier 1553 and “0 to 4999” as the real data storage area block number range 1554.

The first replication request requests to copy, to the block identified by block numbers “0 to 4999” within the real data storage area 204, data stored in the first half data storage area of the tape cartridge 303. The second replication request requests to copy, to the block identified by have block numbers “0 to 4999” within the real data storage area 205, data stored in the second half data storage area of the tape cartridge 303.

The CPU 540 of the backup computer 500 next extracts “303” as the restore source tape cartridge number 941 from the restore request 940 received in Step 1911. The CPU 540 of the backup computer 500 instructs the tape library device 300 to mount the tape cartridge 303 which corresponds to 303′ of the extracted restore source tape cartridge number 941 (1915).

The instruction to mount the tape cartridge 303 is received by the CPU 340 of the tape library device 300. The CPU 340 of the tape library device 300 mounts the tape cartridge 303 to the tape device 320 by controlling the tape cartridge handling mechanism 330. Then the CPU 340 of the tape library device 300 sends a message “mounting completed” to the backup computer 500 in response.

Receiving the message “mounting completed”, the CPU 540 of the backup computer 500 executes the replication requests created in Step 1914 (1916). The CPU 540 of the backup computer 500 implements the replication requests by executing the data transmission program 552. In the case where plural replication requests. are created in Step 1914, the CPU 540 of the backup computer 500 executes the replication requests in order.

Specifically, the CPU 540 of the backup computer 500 executes the first replication request created. As a result, data stored in the first half data storage area of the tape cartridge 303 is copied by the CPU 540 of the backup computer 500 to the block identified by block numbers “0 to 4999” within the real data storage area 204.

The CPU 540 of the backup computer 500 next executes the second replication request created. As a result, data stored in the second half data storage area of the tape cartridge 303 is copied by the CPU 540 of the backup computer 500 to the block identified by block numbers “0 to 4999” within the real data storage area 205.

After finishing executing every replication request that is created in Step 1914, the CPU 540 of the backup computer 500 instructs the tape library device 303 to unmount the tape cartridge 303 (1917).

The instruction to unmount the tape cartridge 303 is received by the CPU 340 of the tape library device 300. The CPU 340 of the tape library device 300 unmounts the tape cartridge 303 from the tape device 320 by controlling the tape cartridge handling mechanism 330. Then the CPU 340 of the tape library device 300 sends a message “unmounting completed” to the backup computer 500 in response.

Receiving the message “unmounting completed”, the CPU 540 of the backup computer 500 sends a message “backup completed” to the computer 10 or the management computer 600 in response (1918). The CPU 540 of the backup computer 500 then ends the backup processing.

According to the second embodiment of this invention, a computer system can restore a virtualized data storage area of a virtualization apparatus by copying data to another real data storage area different from a backup source real data storage area.

### THIRD EMBODIMENT

A virtualization apparatus according to a third embodiment of this invention also virtualizes real data storage areas of a storage system that stores backup data.

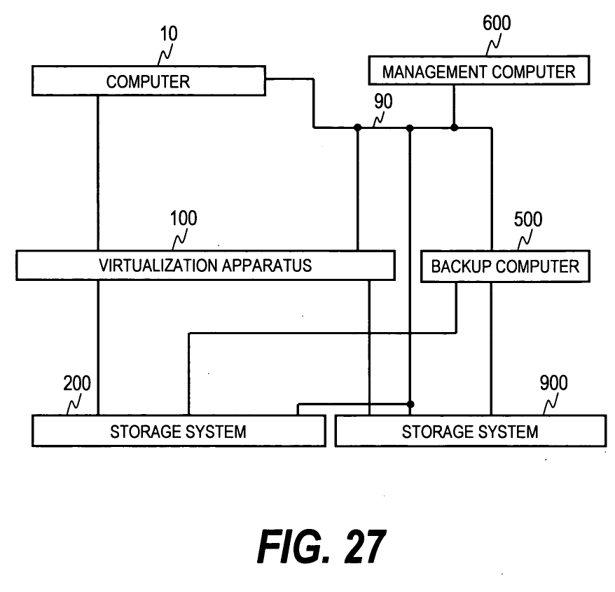

FIG. 27 is a block diagram showing the configuration of a computer system according to the third embodiment of this invention.

The computer system of the third embodiment has a storage system 900 instead of the tape library device 300. In the computer system of the third embodiment, the virtualization apparatus 100 is connected to the storage system 900 via a network to which a fibre channel protocol is applied.

The rest of the configuration of the computer system according to the third embodiment is the same as that of the computer system according to the first embodiment. A description on the configuration will therefore be omitted.

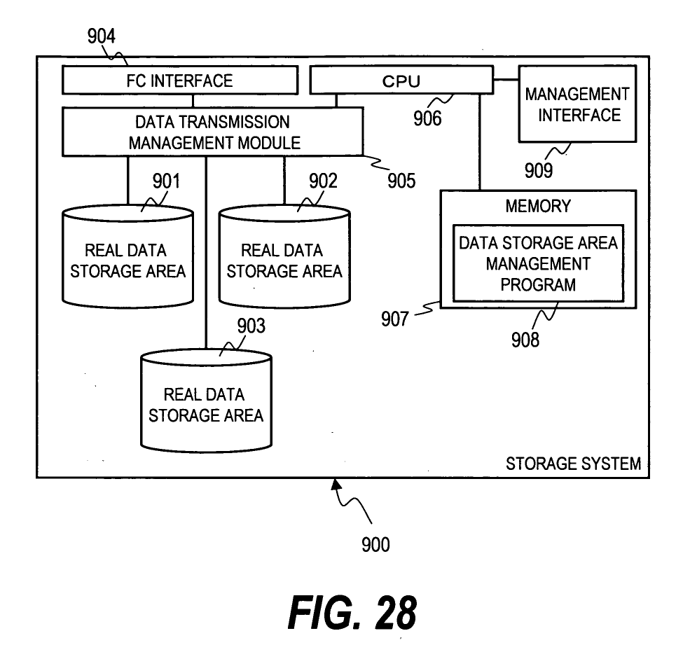

FIG. 28 is a block diagram showing the configuration of the storage system 900 which is provided in the computer system according to the third embodiment of this invention.

The storage system 900 has an FC interface 904, a data transmission management module 905, a CPU 906, a memory 907, a management interface 909, and a disk drive.

The FC interface 904 is connected to the virtualization apparatus 100 and the backup computer 500 via the network to which a fibre channel protocol is applied. The management interface 909 is connected to the management computer 600 via the management network 90.

The data transmission control module 905 controls data transmission between the FC interface 904, the CPU 906, and the disk drive.

The CPU 906 performs various types of processing by executing programs stored in the memory 907.

The memory 907 stores information including programs that are executed by the CPU 906. Specifically, the memory 907 stores a data storage area management program 908.

The data storage area management program 908 processes a read request and a write request that are received from the virtualization apparatus 100. The data storage area management program 908 also provides data storage areas of the disk drive as real data storage areas 901 to 903 to the virtualization apparatus 100.

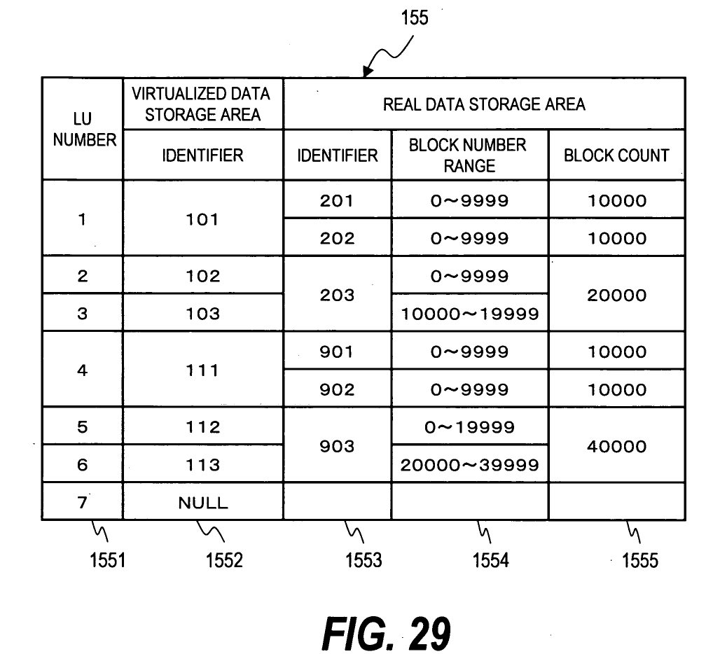

FIG. 29 is configuration diagram of the mapping information 155 stored in the virtualization apparatus 100 according to the third embodiment of this invention.

The mapping information 155 contains an LU number 1551, a virtualized data storage area identifier 1552, a real data storage area identifier 1553, a real data storage area block number range 1554, and a real data storage area block count 1555.

The LU number 1551 indicates an identifier for enabling the computer 10 to identify a virtualized data storage area of the virtualization apparatus 100.

The virtualized data storage area identifier 1552 indicates an identifier unique to a virtualized data storage area in question.

The real data storage area identifier 1553 indicates an identifier unique to virtualized data storage areas 201 to 203 and 901 to 903 in which the data is requested to be written in the virtualized data storage area is actually stored.

The real data storage area block number range 1554 indicates blocks that stores data requested to be written in the virtualized data storage area within the real data storage areas 201 to 203 and 901 to 903.

The real data storage area block count 1555 indicates how many of the blocks that stores data requested to be written in the virtualized data storage area within the real data storage areas 201 to 203 and 901 to 903.

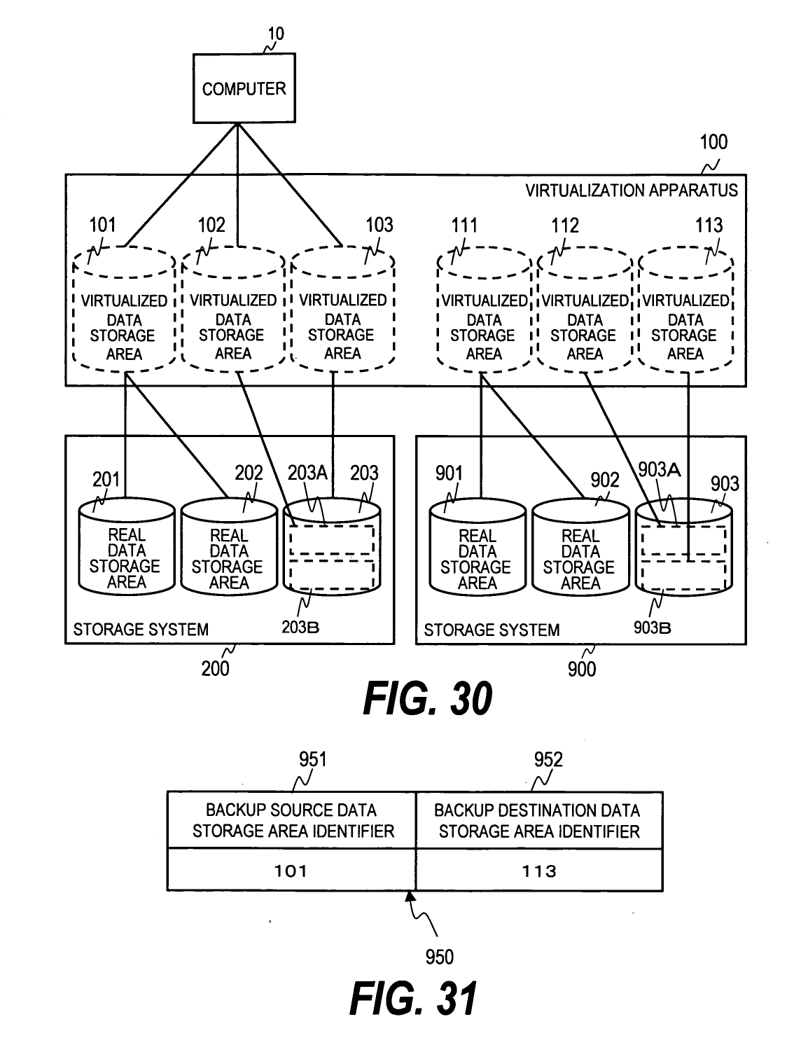

FIG. 30 is an explanatory diagram of the virtualized data storage areas 101 to 103 and 111 to 113 which are provided by the virtualization apparatus 100 according to the third embodiment of this invention.

The virtualization apparatus 100 provides the virtualized data storage areas 101 to 103 to the computer 10. The virtualized data storage area 101 corresponds to the real data storage areas 201 and 202 of the storage system 200. The real data storage area 201 is composed of 10000 blocks. Similarly, the real data storage area 202 is composed of 10000 blocks. The size of each block is, for example, 512 bytes.

Blocks in the first half of the virtualized data storage area 101 (block numbers “0” to “9999”) correspond to the real data storage area 201. Blocks in the second half of the virtualized data storage area 101 (block numbers “10000” to “19999”) correspond to the real data storage area 202.

The virtualized data storage areas 102 and 103 correspond to the real data storage area 203 of the storage system 200. The real data storage area 203 is composed of 20000 blocks.

The virtualized data storage area 102 corresponds to a block group 203A in the first half of the real data storage area 203 (block numbers “0” to “9999”). The virtualized data storage area 103 corresponds to a block group 203B in the second half of the real data storage area 203 (block numbers “10000” to “19999”).

The virtualization apparatus 100 provides the virtualized data storage areas 111 to 113. The virtualized data storage area 111 corresponds to the real data storage areas 901 and 902 of the storage system 900. The real data storage area 901 is composed of 10000 blocks. Similarly, the real data storage area 902 is composed of 10000 blocks.

Blocks in the first half of the virtualized data storage area 111 (block numbers “0” to “9999”) correspond to the real data storage area 901. Blocks in the second half of the virtualized data storage area 111 (block numbers “10000” to “19999”) correspond to the real data storage area 902.

The virtualized data storage areas 112 and 113 correspond to the real data storage area 903 of the storage system 900. The real data storage area 903 is composed of 40000 blocks.

The virtualized data storage area 112 corresponds to a block group 203A in the first half of the real data storage area 903 (block numbers “0” to “19999”). The virtualized data storage area 113 corresponds to a group of block 903B in the second half of the real data area 903 (block numbers “20000 to 39999”).

Next, backup processing of the computer system according to the third embodiment of this invention will be described.

FIG. 31 is an explanatory diagram of a backup request 950 according to the first embodiment of this invention.

The backup request 950 contains a backup source data storage area identifier 951 and a backup destination data storage identifier 952.

The backup source data storage area identifier 951 indicates an identifier unique to a virtualized data storage area that stores data requested to be backed up. The backup destination data storage area number 952 indicates an identifier unique to the virtualized data storage area that stores backup data of the virtualized data storage area corresponding to the backup source data storage area identifier 951.

The backup request 950 of FIG. 31 requests to back up data of the virtualized data storage area 101 to the virtualized data storage area 113.

The description given here is backup processing of when the CPU 540 of the backup computer 500 receives a backup request shown in FIG. 31.

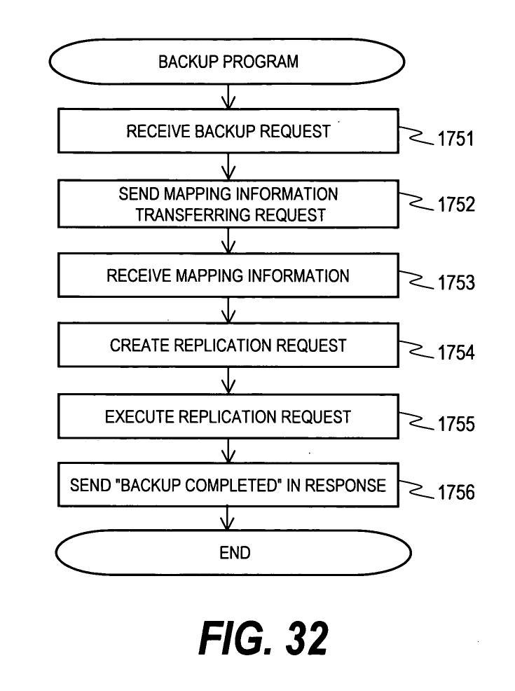

FIG. 32 is a flow chart for backup processing of the backup computer 500 according to the third embodiment of this invention.

The CPU 540 of the backup computer 500 first receives the backup request 950 from the backup request issuing program 16 of the computer 10 or from the backup request issuing program 651 of the management computer 600 (1701).

Receiving the request, the CPU 540 of the backup computer 500 sends a mapping information transferring request to the virtualization apparatus 100 (1752).

The mapping information transferring request is received by the CPU 140 of the virtualization apparatus 100. The CPU 140 of the virtualization apparatus 100 sends the mapping information 155 stored in the memory 150 to the backup computer 500.

The CPU 540 of the backup computer 500 receives the mapping information 155 (1753)., The CPU 540 of the backup computer 500 stores the received mapping information 155 in the mapping information holding area 555 of the memory 550.

The mapping information 155 stored in the mapping information holding area 555 is consulted by the CPU 540 of the backup computer 500 in creating a replication request based on the backup request that has been received in Step 1751 (1754).

Specifically, the CPU 540 of the backup computer 500 chooses a record entry of the mapping information 155 whose virtualized data storage area identifier 1552 matches “101” contained as the backup source data storage area identifier 951 in the backup request 950. The CPU 540 of the backup computer 500 extracts from the chosen record entry the real data storage area identifier 1553 and the real data storage area block number range 1554. In this example, the CPU 540 of the backup computer 500 extracts a combination of “201” as the real data storage area identifier 1553 and “0 to 9999” as the real data storage area block number range 1554, and a combination of “202” as the real data storage area identifier 1553 and “0 to 9999” as the real data storage area block number range 1554.

The CPU 540 of the backup computer 500 next chooses a record entry of the mapping information 155 whose virtualized data storage area identifier 1552 matches “113” contained as the backup destination data storage area identifier 952 in the backup request 950. From the chosen record entry, the CPU 540 of the backup computer 500 extracts “903” as the real data storage area identifier 1553 and “20000 to 39999” as the real data storage area block number range 1554.

The CPU 540 of the backup computer 500 then creates a replication request from the extracted real data storage area identifier 1553 and real data storage area block number range 1554. In this example, the CPU 540 of the backup computer 500 creates a first replication request and a second replication request. Specifically, the CPU 540 of the backup computer 500 creates the first replication request from the combination of “201” as the real data storage area identifier 1553 and “0 to 9999” as the real data storage area block number range 1554, and creates the second replication request from the combination of “202” as the real data storage area identifier 1553 and “0 to 9999” as the real data storage area block number range 1554.

The first replication request requests to copy, to the blocks identified by block numbers “20000 to 29999” within the real data storage area 903, data of blocks identified by block numbers “0 to 9999” within the real data storage area 201. The second replication request requests to copy, to the blocks identified by block numbers “30000 to 39999” within the real data storage area 903, data of blocks identified by block numbers “0 to 9999” within the real data storage area 202.

The CPU 540 of the backup computer 500 implements the created replication requests by executing the data transmission program 552 (1755). In the case where plural replication requests are created, the CPU 540 of the backup computer 500 executes the replication requests in order.

Specifically, the CPU 540 of the backup computer 500 executes the first replication request created. As a result, data of blocks identified by block numbers “0 to 9999” within the real data storage area 201 is copied by the CPU 540 of the backup computer 500 to the blocks identified by block numbers “20000 to 29999” within the real data storage area 903.

The CPU 540 of the backup computer 500 next executes the second replication request created. As a result, data of blocks identified by block numbers “0 to 9999” within the real data storage area 202 is copied by the CPU 540 of the backup computer 500 to the blocks identified by block numbers “30000 to 39999” within the real data storage area 903.

After finishing executing every replication request that is created in Step 1754, the CPU 540 of the backup computer 500 sends a message “backup completed” to the computer 10 or the management computer 600 (1756). The CPU 540 of the backup computer 500 then ends the processing of the backup program 551.

As described above, the CPU 540 of the backup computer 500 creates a replication request consulting the mapping information 155 and based on a backup request, and executes the thus created replication request. This enables the computer system of this embodiment to back up data of the virtualized data storage area 101, which is provided by the virtualization apparatus 100, to the virtualized data storage area 113, which is another virtualized data storage area provided by the virtualization apparatus 100, without sending backup data to the virtualization apparatus 100. The computer system of this embodiment can therefore lessen the load on the virtualization apparatus 100 during backup processing.

While the present invention has been described in detail and pictorially in the accompanying drawings, the present invention is not limited to such detail but covers various obvious modifications and equivalent arrangements, which fall within the purview of the appended claims.

What is claimed is:

1. A computer system, comprising:
at least one first storage system;
at least one second storage system;
a virtualization apparatus connected to the first storage system;
at least one host computer connected to the virtualization apparatus;
a backup unit having access to the virtualization apparatus; and
a data transmission unit having access to the first storage system, the second storage system, and the backup unit,
wherein each first storage system comprises a first interface connected to the virtualization apparatus, a first processor connected to the first interface, a first memory connected to the first processor, and a first disk drive for storing data requested by the host computer to be written,
wherein each second storage system comprises a second interface connected externally, a second processor connected to the second interface, a second memory connected to the second processor, and a storage unit for storing a copy of data stored in the first disk drive,
wherein the virtualization apparatus comprises a third interface connected to the first storage system and the host computer, a third processor connected to the third interface, and a third memory connected to the third processor,
wherein the third processor provides, to the host computer, a virtualized data storage area in which data is requested to be written by the host computer,
wherein the first processor provides a data storage area of the first disk drive as at least one first data storage area to the virtualization apparatus, and stores in the first data storage area data that is requested to be written in the virtualized data storage area,
wherein, when requested to take a backup of the virtualized data storage area, the backup unit obtains mapping information which indicates association between the virtualized data storage area and the first data storage area where data requested to be written in the virtualized data storage area is stored, and identifies, based on the obtained mapping information, the first data storage area corresponding to the virtualized data storage area that is requested to be backed up, and
wherein the data transmission unit transfers, to the storage unit of the second storage system, a copy of data stored in the first data storage area that is identified by the backup unit.

2. The computer system according to claim 1, wherein the backup unit and the data transmission unit function by having the second processor execute programs that are stored in the second memory, and are comprised in the second storage system.

3. The computer system according to claim 1, further comprising a backup computer connected to the first storage system, the second storage system, and the virtualization apparatus,
wherein the backup computer comprises a fourth interface connected to the first storage system, the second storage system, and the virtualization apparatus, a fourth processor connected to the fourth interface, and a fourth memory connected to the fourth processor, and
wherein the backup unit and the data transmission unit function by having the fourth processor execute programs that are stored in the fourth memory, and are comprised in the backup computer.

4. The computer system according to claim 1, further comprising a data transmission computer connected to the first storage system, the second storage system, and the virtualization apparatus,
wherein the data transmission computer comprises a fourth interface connected to the first storage system, the second storage system, and the virtualization apparatus, a fourth processor connected to the fourth interface, and a fourth memory connected to the fourth processor,
wherein the data transmission unit function by having the fourth processor execute programs that are stored in the fourth memory, and are comprised in the data transmission computer, and
wherein the backup unit functions by having the third processor execute programs that are stored in the third memory, and are comprised in the virtualization apparatus.

5. The computer system according to claim 1, wherein the virtualization apparatus comprises a second disk drive for storing data requested by the host computer to be written.

6. The computer system according to claim 1,
wherein the third memory stores the mapping information, and
wherein, when requested to take a backup of the virtualized data storage area, the backup unit obtains the mapping information from the third memory.

7. The computer system according to claim 1,
wherein the mapping information contains association between the virtualized data storage area and a block that stores data requested to be written in the virtualized data storage area,
wherein the backup unit identifies, based on the obtained mapping information, the block corresponding to the virtualized data storage area that is requested to be backed up, and
wherein the data transmission unit transfers, to the storage unit of the second storage system, a copy of data stored in a block that is identified by the backup unit within the first data storage area that is identified by the backup unit.

8. The computer system according to claim 1,
wherein, when requested to restore the virtualized data storage area, the backup unit obtains the mapping information and identifies, based on the obtained mapping information, the first data storage area corresponding to the virtualized data storage area that is requested to be restored, and
wherein the data transmission unit transfers, to the first data storage area that is identified by the backup unit, a copy of data stored in the storage unit of the second storage system.

9. The computer system according to claim 1,
wherein the storage unit of each second storage system is a second disk drive, and
wherein the second processor provides a data storage area of the second disk drive as at least one second data storage areas to the virtualization apparatus.

10. The computer system according to claim 9,
wherein the backup unit identifies, based on the obtained mapping information, the second data storage area corresponding to a virtualized data storage area that is designated in a backup request as a backup destination, and
wherein the data transmission unit transfers, to the second data storage area that is identified by the backup unit, a copy of data stored in the first data storage area that is identified by the backup unit.

11. A data replication method for a computer system,
the computer system comprising:
at least one first storage system;
at least one second storage system;
a virtualization apparatus connected to the first storage system;
at least one host computer connected to the virtualization apparatus;
a backup unit having access to the virtualization apparatus; and
a data transmission unit having access to the first storage system, the second storage system, and the backup unit,
wherein each first storage system comprises a first interface connected to the virtualization apparatus, a first processor connected to the first interface, a first memory connected to the first processor, and a first disk drive for storing data requested by the host computer to be written,
wherein each second storage system comprises a second interface connected externally, a second processor connected to the second interface, a second memory connected to the second processor, and a storage unit for storing a copy of data stored in the first disk drive,
wherein the virtualization apparatus comprises a third interface connected to the first storage system and the host computer, a third processor connected to the third interface, and a third memory connected to the third processor,
wherein the third processor provides, to the host computer, a virtualized data storage area in which data is requested to be written by the host computer,
wherein the first processor provides a data storage area of the first disk drive as at least one first data storage area to the virtualization apparatus, and stores in the first data storage area data that is requested to be written in the virtualized data storage area,
the data replication method comprising:
a first step of, when requested to take a backup of the virtualized data storage area, obtaining mapping information which indicates association between the virtualized data storage area and the first data storage area where data requested to be written in the virtualized data storage area is stored;
a second step of identifying, based on the obtained mapping information, the first data storage area corresponding to the virtualized data storage area that is requested to be backed up; and
a third step of transferring, to the storage unit of the second storage system, a copy of data stored in the identified first data storage area.

12. The data replication method according to claim 11, wherein the second processor executes the first step, the second step, and the third step.

13. The data replication method to claim 11,
wherein the computer system comprises a backup computer connected to the first storage system, the second storage system, and the virtualization apparatus,
wherein the backup computer comprises a fourth interface connected to the first storage system, the second storage system, and the virtualization apparatus, a fourth processor connected to the fourth interface, and a fourth memory connected to the fourth processor, and
wherein the fourth processor executes the first step, the second step, and the third step.

14. The data replication method according to claim 11,
wherein the computer system comprises a data transmission computer connected to the first storage system, the second storage system, and the virtualization apparatus,
wherein the data transmission computer comprises a fourth interface connected to the first storage system, the second storage system, and the virtualization apparatus, a fourth processor connected to the fourth interface, and a fourth memory connected to the fourth processor,
wherein the third processor executes the first step and the second step, and
wherein the fourth processor executes the third step.

15. The data replication method according to claim 11,
wherein the mapping information contains association between the virtualized data storage area and a block that stores data requested to be written in the virtualized data storage area,
wherein the data replication method further comprises a fourth step of identifying, based on the obtained mapping information, the block corresponding to the virtualized data storage area that is requested to be backed up, and
wherein, in the third step, a copy of data stored in the identified block within the identified first data storage area is transferred to the storage unit of the second storage system.

16. The data replication method according to claim 11, further comprising:
a fourth step of obtaining the mapping information as restoration of the virtualized data storage area is requested;
a fifth step of identifying, based on the obtained mapping information, the first data storage area corresponding to the virtualized data storage area that is requested to be restored; and
a sixth step of transferring a copy of data stored in the storage unit of the second storage system to the identified first data storage area.

17. The data replication method according to claim 11,
wherein the storage unit of each second storage system is a second disk drive,
wherein the second processor provides a data storage area of the second disk drive as at least one second data storage areas to the virtualization apparatus,
wherein the data replication method further comprises a fourth step of identifying, based on the obtained mapping information, the second data storage area corresponding to a virtualized data storage area that is designated in a backup request as a backup destination, and
wherein, in the third step, a copy of data stored in the identified first data storage area is transferred to the identified second data storage area.

18. A backup computer connected to at least one first storage system, at least one second storage system, and a virtualization apparatus, wherein:
the virtualization apparatus is connected to the first storage system and a host computer;
the virtualization apparatus provides to the host computer a virtualized data storage area in which data is requested to be written by the host computer;
each first storage system comprises a first disk drive for storing data requested by the host computer to be written;
the first storage system provides a data storage area of the first disk drive as at least one first data storage area to the virtualization apparatus;
the first storage system stores, in the first data area, data requested to be written in the virtualized data storage area; and
each second storage system comprises a storage unit for storing a copy of data that is stored in the first disk drive,
wherein, when requested to take a backup of the virtualized data storage area, the backup computer obtains mapping information which indicates association between the virtualized data storage area and the first storage area where data requested to be written in the virtualized data storage area is stored,
wherein the backup compute identifies, based on the obtained mapping information, the first data storage area corresponding to the virtualized data storage area that is requested to be backed up, and
wherein the backup computer transfers, to the storage unit of the second storage system, a copy of data stored in the identified first data storage area.

19. The backup computer according to claim 18,
wherein the mapping information contains association between the virtualized data storage area and a block that stores data requested to be written in the virtualized data storage area,
wherein the backup computer identifies, based on the obtained mapping information, the block corresponding to the virtualized data storage area that is requested to be backed up, and
wherein the backup computer transfers, to the storage unit of the second storage system, a copy of data stored in the identified block within the identified first data storage area.

20. The backup computer according to claim 18,
wherein, when requested to restore the virtualized data storage area, the backup computer obtains the mapping information,
wherein the backup computer identifies, based on the obtained mapping information, the first data storage area corresponding to the virtualized data storage area that is requested to be restored, and
wherein the backup computer transfers, to the identified first data storage area, a copy of data stored in the storage unit of the second storage system.
